(19) United States
(12) Patent Application Publication
(10) Pub. No.: US 2025/0087974 A1
(43) Pub. Date: Mar. 13, 2025

(54) MODULAR ARCHITECTURE FOR MANAGING SITE-LEVEL ELECTRICAL POWER DISTRIBUTION

(71) Applicant: Span.IO, Inc., San Francisco, CA (US)

(72) Inventors: Jack Jester Weinstein, Oakland, CA (US); Ian Casimir Dimen, Berkeley, CA (US); Cole Hamilton Ashman, San Francisco, CA (US)

(21) Appl. No.: 18/586,365

(22) Filed: Feb. 23, 2024

Related U.S. Application Data
(60) Provisional application No. 63/581,780, filed on Sep. 11, 2023.
(60) Provisional application No. 63/557,340, filed on Feb. 23, 2024.

(51) Int. Cl. H02B 1/04; H02B 1/20; H02J 3/38; H02J 13/00

(52) U.S. Cl. CPC H02B 1/04; H02B 1/20; H02J 3/381; H02J 13/0002; H02J 2203/10; H02J 2310/12

(57) ABSTRACT

A system for managing electrical power distribution for the microgrid at a site includes a customizable modular smart panel chassis and a set of chassis-compatible hardware modules. The chassis is designed to hold the hardware modules, which in turn are connected to circuits. The modules are field-installable and field-replaceable. Accordingly, more modules may be added as more circuits are added and/or as more management capabilities become available. The chassis itself may also be field-customizable, for example extendible in size to accommodate more modules.

### CROSS-REFERENCE TO RELATED APPLICATION(S)

This application claims priority under 35 U.S.C. § 119 (e) to U.S. Provisional Patent Application Ser. No. 63/557,340, “Modular Architecture for Managing Site-Level Electrical Power Distribution,” filed Feb. 23, 2024; and to U.S. Provisional Patent Application Ser. No. 63/581,780, “Modular Architecture for Managing Site-Level Electrical Power Distribution,” filed Sep. 11, 2023. The subject matter of all of the foregoing is incorporated herein by reference in their entirety.

### BACKGROUND

### 1. Technical Field

This disclosure relates generally to management and control of the distribution of electrical power.

### 2. Description of Related Art

Continued electrification will add massive amounts of demand to electrical distribution. Estimates are that net distribution capacity in the U.S. will increase by two to three times to support fully renewable energy sources. The current distribution system and site-level (e.g. building) wiring are not well instrumented and not easily controllable. They are not well suited to implement sophisticated energy management.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIGS. 1, 2 and 3 are diagrams of various sites with a modular system for managing electrical power distribution throughout a microgrid at the site.

FIGS. 4, 5 and 6 are diagrams illustrating electronic overload protection.

FIG. 7 shows some residential home topologies.

FIG. 8 shows an electrical panel with a modular chassis.

FIGS. 9, 10, 11 and 12 are diagrams of various sites with a modular system for managing electrical power distribution throughout a microgrid at the site.

FIG. 13 is a block diagram of a modular system for managing electrical power distribution throughout a microgrid at a site.

FIG. 14 is a block diagram of a module from the modular system of FIG. 13.

FIG. 15 is a block diagram of a chassis from the modular system of FIG. 13.

FIG. 16 is a block diagram of a heads and tails communication topology, suitable for use with the modular system of FIG. 13.

FIG. 17 is a block diagram showing implementation of a heads and tails communication topology.

FIG. 18 is a block diagram of an electrical panel, suitable for use with a modular system for managing electrical power distribution.

FIG. 19 is a block diagram of a branch module from the electrical panel of FIG. 18.

FIG. 20 is a block diagram of a panel control module from the electrical panel of FIG. 18.

FIGS. 21A and 21B are block diagrams of MID and main breaker modules from the electrical panel of FIG. 18.

FIG. 21C illustrates use of a MID/main breaker module.

FIG. 22 is a block diagram of a standalone gateway and site meter module.

FIG. 23 is a block diagram of a standalone EVSE module.

FIG. 24 is a block diagram of a standalone smart junction box.

FIG. 25 is a block diagram of a standalone smart outlet.

FIG. 26A is a block diagram of a multi-layer power flow control.

FIG. 26B is a block diagram of a multi-layer power flow control using distributed control modules.

FIG. 27 is a block diagram of software-defined load management.

FIGS. 28A and 28B are diagrams of monitor/interrupter power management patterns.

FIG. 29 illustrates two control schemes for monitor/interrupter interactions.

FIG. 30 shows a sequence diagram for configuration of a failsafe contract.

FIG. 31 shows an implementation of a communications timeout.

FIG. 32 is a diagram showing different types of modules.

FIG. 33A shows interfaces to a panel control module.

FIG. 33B shows some interfaces to a gateway module.

FIG. 33C shows interfaces to a branch module.

FIG. 33D shows interfaces to a mains module.

FIG. 33E is a table showing different combinations of main breaker and MID capabilities.

FIG. 33F shows a metered lug.

FIG. 34 shows different electrical panels constructed using the modules of FIGS. 32-33.

FIGS. 35 and 36 are diagrams of various site configurations, using the modules described herein.

FIG. 37 shows different possible placements for a gateway module.

FIGS. 38A-38E are diagrams of additional examples of site configurations.

### DETAILED DESCRIPTION

### I. Introduction

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

With increased electrification, there is a need for more sophisticated management and control of electrical power distribution at the site-level, for example for residential homes and commercial properties. The site-level electrical power distribution system is referred to as a microgrid. It would be beneficial if management of the microgrid was integrated into structures and other sites in the same way as heating, plumbing, and lighting. It would also be beneficial if this integration was modular and field-customizable. This would allow installers to retrofit more sophisticated power management to existing structures and to modify those capabilities as the electrical needs grow or change and as more capabilities become available.

In one approach, a system for managing electrical power distribution for the microgrid at a site includes a customizable modular smart panel chassis and a set of chassis-compatible hardware modules. The chassis is designed to hold the hardware modules, which in turn are connected to circuits. The modules are field-installable and field-replaceable. Accordingly, more modules may be added as more circuits are added and/or as more management capabilities become available. The chassis itself may also be field-customizable, for example extendible in size to accommodate more modules.

The system further includes control loops for the individual circuits of the microgrid. A typical control loop includes a sensor(s), processing and an actuator(s). The system may be distributed, meaning that these components may be positioned at different physical locations throughout the distribution network. For example, sensors may be positioned at outlets or electrical fixtures, instead of or in addition to being positioned at the panel. Processing for the control loops may be implemented by shared processors rather than dedicated processors, thus reducing the overall cost of the system. Actuators may also be positioned at different points within the distribution network.

Panel modularity. Constructing a panel out of chassis-compatible modules (chassis modules) allows the shipment of smart panels that are highly customizable and are also much easier to service (because parts can be replaced in sections).

Site-level safety, distributed hardware. In addition, nodes can coordinate to provide safety functions for the site overall, especially electronic overload protection for service wires, electrical panels, and feeders. Installing hard-wired communications links between nodes should be optional and only done when convenient. Building electrification may be retrofits on existing stock, and hardware will often “belong” at different sides of a house. For example, a house might have a meter/combo panel on one side and a subpanel across the house in the garage. Running new communications wiring through a building is relatively easy when the building is under construction, but difficult and expensive when the building is already finished. Aspects of the system architecture may be based around direct wireless/PLC coordination between microcontrollers and the modular chassis in a smart panel. Some aspects include control which allow the system to gracefully degrade and fail safe in case of communications loss.

The modular, customizable approach can have the following advantages. It can reduce the cost of implementing these controls. It can provide short-term cost savings on electrification upgrades. It can be mass manufacturable, further reducing costs. It can be easier and lower cost to manufacture and assemble.

It is serviceable. The ability to replace and upgrade modules means that fixing hardware failures will be substantially faster, cheaper, and less disruptive to homeowners than replacing an entire backplate. The panel and modules may also include improved self-monitoring to be able to detect module hardware failures.

It is customizable. Because this approach provides a “menu” of hardware product options that installers can choose from for each site, the system's ability to see and control is improved at the same time as the system becomes cheaper and easier to install.

The following are some examples.

### A. Cost Reduction With Custom-Sized Panels

Consider the following situation. The homeowner is installing a backup battery and wants control over all their branch circuits. All branch circuits in the home currently land in two 16-circuit interior subpanels. The homeowner also hopes to avoid a service upgrade.

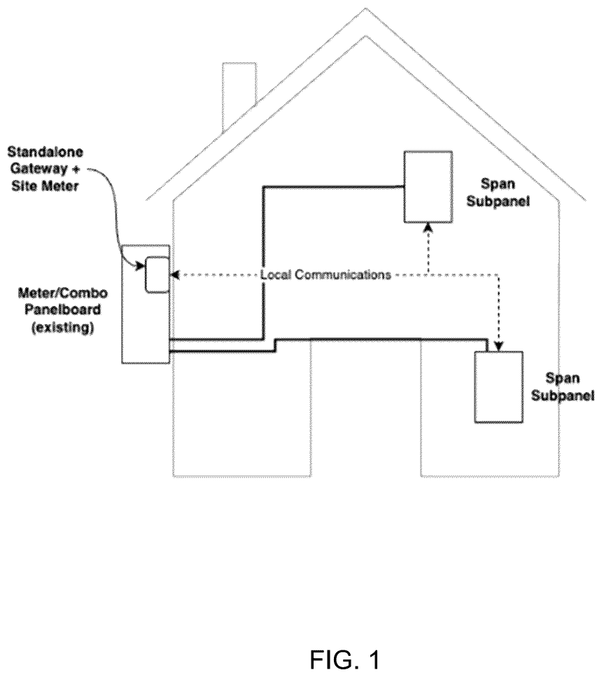

As shown in FIG. 1, with customizable sizes and configurations of panels, this allows the installation of smart subpanels customized to 16-circuits without a MID (microgrid interconnect device) or gateway. In FIG. 1, these are labeled as Span subpanels, because Span is a company developing such subpanels and other components and devices for the overall system. Installation becomes cheaper, because the subpanels can be customized to match the size of the current subpanels. There is no need to cut a larger opening in the wall and possibly extend wires. In addition, not having to run wired communications also saves installer effort.

### B. Cost Reduction With Standalone Modules

For a more dramatic example, consider the following. The homeowner wants to add a Level 2 EVSE to charge their new electric vehicle. They want to avoid upgrading their service from the grid. The garage is on the opposite side of the house, fed by a pre-existing subpanel and feeder.

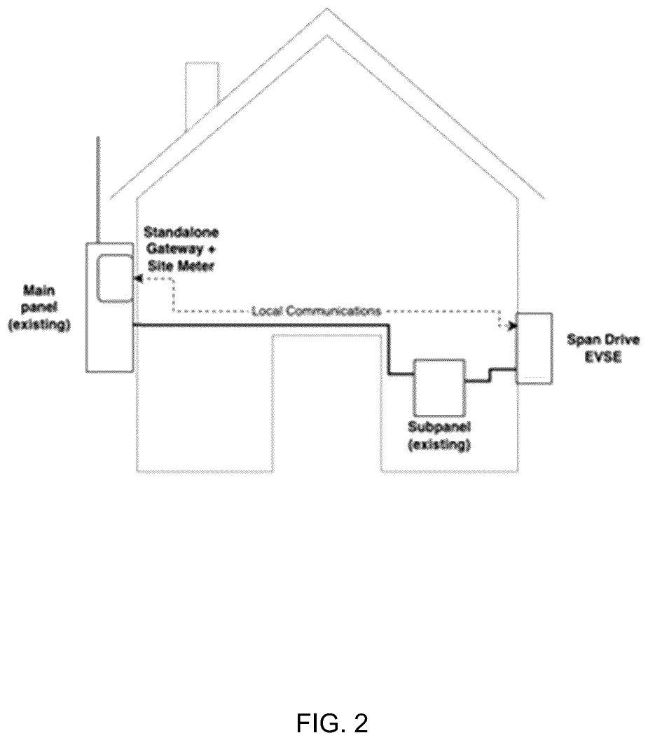

As shown in FIG. 2, the distributed modular approach allows the installer to install a site meter and EVSE and coordinate them directly over wireless communications, omitting the panel replacement entirely and providing the same experience for a reduced cost.

### C. Better Experience With Outlet-Level Monitoring

Finally, consider the following situation. The homeowner is installing a storage battery and wants smart backup load control. The homeowner is not cost-sensitive and is interested in having as much monitoring and control as possible. The homeowner has a number of energy-intensive loads on 120VAC circuits, e.g. space heaters.

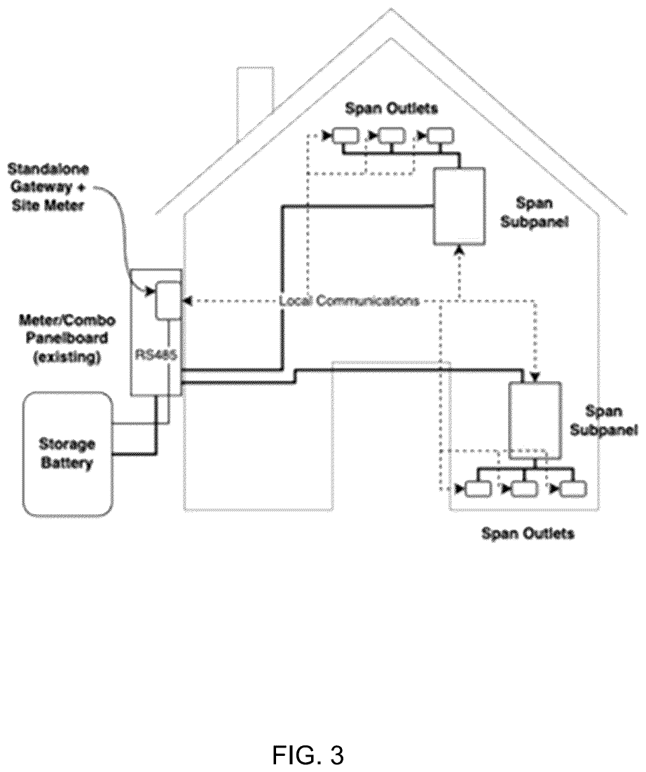

As shown in FIG. 3, in this case, the support for distributed modules allows us to offer smart outlets which seamlessly integrate with the rest of the energy system. The local coordination allows the entire site to coordinate to manage battery energy and power.

### II. Electronic Overload Protection

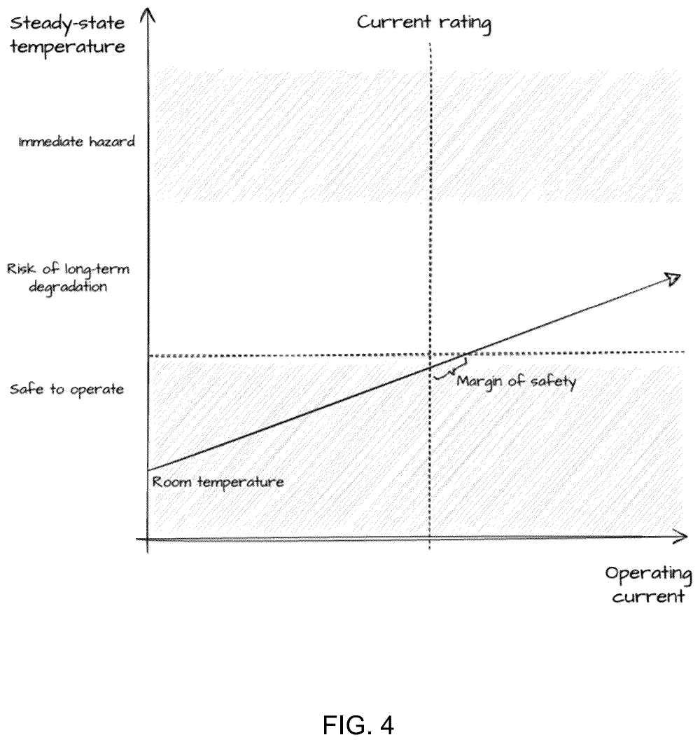

The system described herein can provide electronic overload protection. “Electronic overload protection” refers to the practice of using electronic control systems to prevent overload in electrical conductors (wires, buswork). See FIG. 4. This could also apply to other distribution elements like transformers. Conducting electricity generates heat due to ohmic losses, as no conductor is perfect and every material has non-zero resistance. Conductors are sold with maximum current ratings representing the maximum current which the conductor can always carry safely (within the bounds of expected application). Exceeding the rating of a conductor can cause that conductor to overheat. This can cause immediate hazard, e.g. if an in-wall conductor heats enough to ignite adjacent building material. It can also cause long-term hazard by degrading materials, for example causing jacketing on a wire to slowly drip off the wire until the wire is exposed, or charring wood and thus reducing its flash point over time.

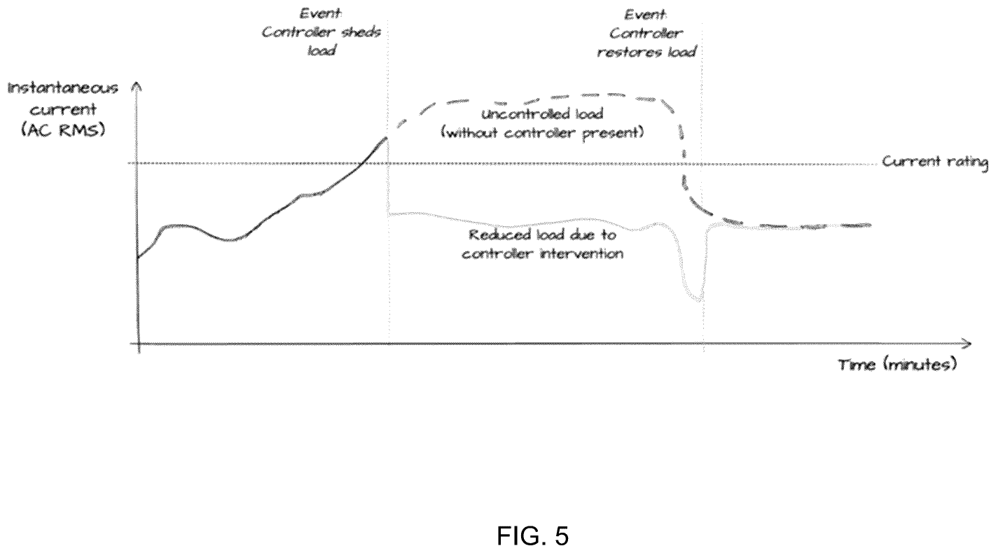

An electronic overload protection device is responsible for keeping wires in the “safe to opearte” region and avoiding risk of fire. To do so, a controller exerts control over the amount of load on a conductor. It also monitors the current through the conductor and uses that control to reduce load current when it exceeds the device's rating (or some other threshold as appropriate). See FIG. 5.

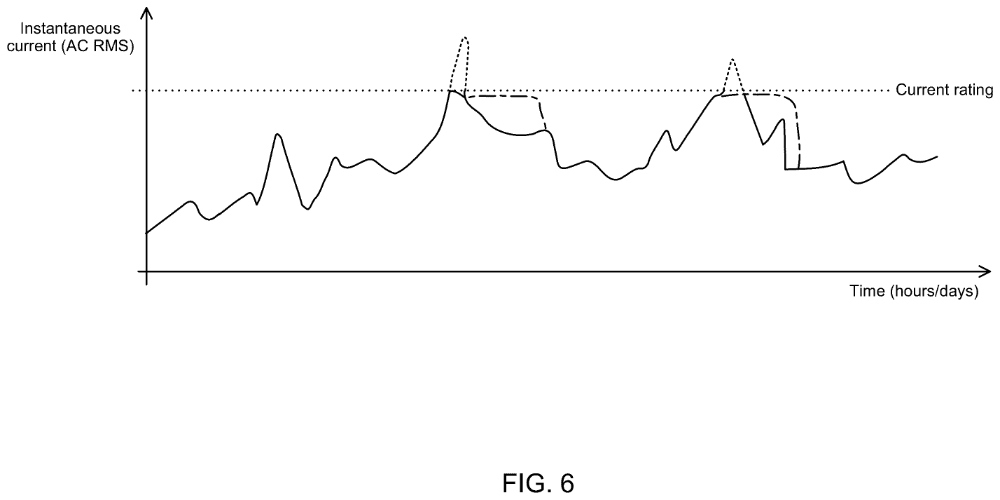

Electrification is the process of replacing natural-gas and gasoline-fired appliances and vehicles with electric alternatives. This results in more current draw in the home. Electronic overload protection devices can prevent wiring upgrades by flattening out demand over time. See FIG. 6. In other words, there is opportunity to increase energy consumption (average power over time) without upgrading current rating. This can often be cheaper over a service upgrade.

### III. Customization

Houses are built and wired by electricians on a one-by-one basis (or sometimes in sets of 10-100 s, as in tract housing), and then frequently modified to suit their occupants. This means that the electrical topology of houses can be quite varied. For that reason, the “perfect” home energy management system looks different for each house. A modular customizable system will allow installers to build electronic overload protection/home energy management “from the catalog” for each house, rather than trying to deliver that function as a single “one size fits most” product.

### A. Custom Sizes of Panel

Different homes use electrical panels of different sizes. Some homes use a 32-48 circuit main panel; other homes are built with most of their circuits landed in subpanels (smaller “satellite” panels with 8-24 circuits). Installers have frequently found themselves using a larger standard size smart panel to replace subpanels, because that is what is available. That is an extra expense. In addition to costing more, a panel that is too big for the job can also make the installation more difficult. Installers may have to cut out additional drywall, rearrange conductors in the wall, and/or painstakingly splice in extensions to the wires they are working with.

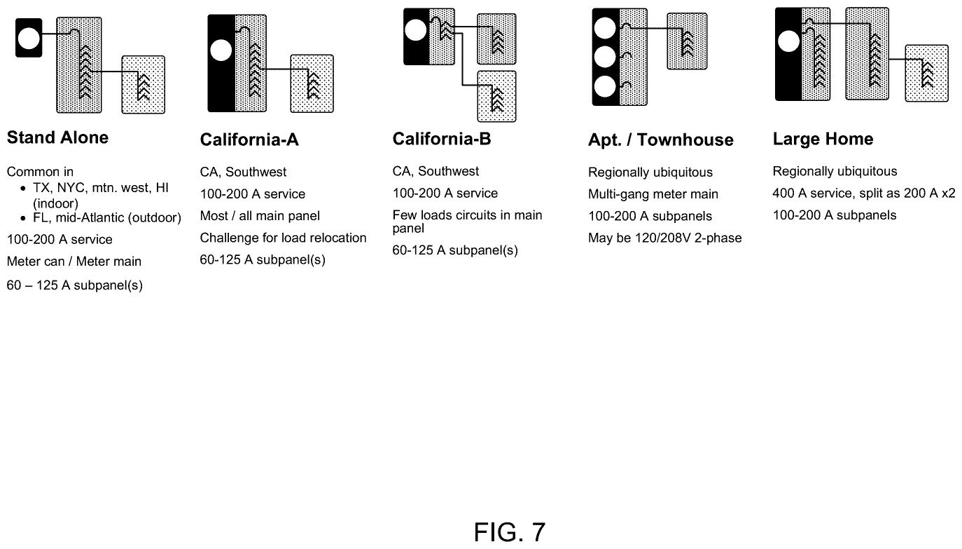

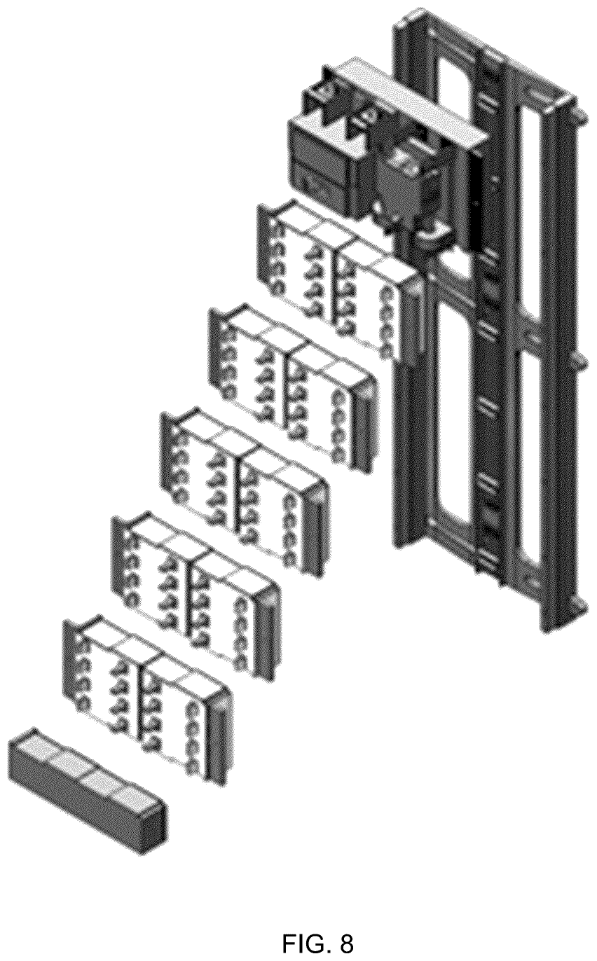

FIG. 7 shows some common residential home topologies. Note the varying number and size of subpanels even within single-family construction. To ensure that installers always have panels that are the right size for the job, the system described herein features an electrical panel with a modular chassis which allows us to compose panels of arbitrary size. To accomplish this, the system panel splits the breaker terminal section of the backplate into 4″ tall segments which can be recombined within the chassis as needed. See FIG. 8.

### B. Distributed Modules

Taking the concept of customization a little further, in some homes it might not be necessary or desirable to replace the panel at all. In new construction, using smart panels is an obvious and excellent place to integrate. However, most installations over the next decade will be retrofits, in which case the effort to remove and replace an electrical panel is a substantial barrier to installing smart hardware.

For retrofit applications, the installer may instead add dedicated hardware for metering/control of only the specific appliances/circuits that would be enrolled in load shed, which could be as few as 2-5 circuits/appliances in a house. This could result in reduced as-installed costs, requiring a fraction of both hardware cost and install time.

In many other sites, the installer may use a combination of panels and standalone modules. For example, rather than using two subpanels, the installer might be able to install one new smart subpanel and then add a single channel of metering and control to an appliance on another subpanel.

For this purpose, the system architecture is intentionally constructed to allow for modules that are “standalone”, meaning not integrated into the panel chassis, and which nonetheless integrate seamlessly into the building energy control system along with chassis modules.

Wireless communication is used to allow the system to distribute hardware through the house. This is not inherently limited to equipment which happens to be panel-shaped.

### C. Avoiding Panel Upgrades

The two major cost adders for residential building electrification are service upgrades (i.e. up-sizing the wire from the grid to the main panel) and main panel upgrades (“MPUs”) (i.e. upsizing the internal busbars inside the main panel). Including standalone modules in the product suite increases the addressable market for electronic overload protection significantly by helping homeowners avoid MPUs as well as service upgrades.

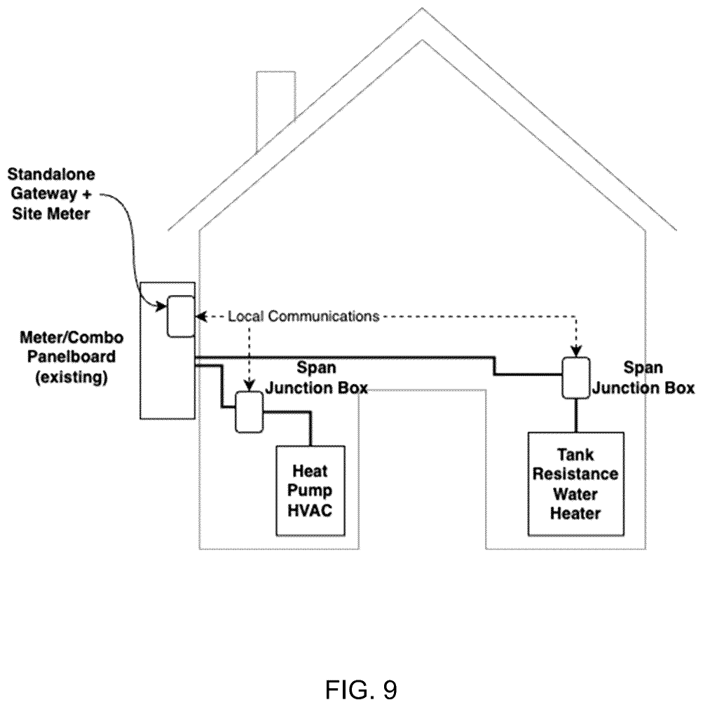

The distributed approach in the system discussed herein can be used to build small overload protection systems for individual panels at competitive prices. A common use case will be the need to avoid a main panel upgrade when installing one or a few new electric appliances. FIG. 9 shows one such example. Let's imagine that the homeowner wants to install a new heat pump and does not quite have the amps for it. A low-cost solution might be to install a smart junction box upstream of the new heat pump's compressor and the existing electric water heater. (Adding the water heater to the “PowerUp” system provides an alternate option for load to shed with reduced impact on the homeowner.)

### D. Reducing Duplication of Components

To pursue building integrated energy management at reduced cost, one principle is to not install any duplicate or redundant hardware into sites. One hardware component that is typically duplicated in today's installations is the gateway, i.e. the processor (typically a Linux computer, sometimes a microcontroller) that manages the connection to the Internet or other off-site external communications. Most solar inverters, backup batteries, EV chargers, energy management systems and other hardware devices come with their own, so it is fairly common to end up with 2-4 gateways at a single site.

Industrial-grade Linux computers are not cheap, and so reducing to one gateway per site can bring substantial potential cost savings. There may also be functional benefits, as a single Linux controller with access to all the energy data in the house may be able to provide better site-level optimization than multiple separate Linux controllers with limited views.

The distributed system may accordingly be designed around a single computer. This computer serves as the gateway for all relevant hardware on the site, as well as providing site-level controls such as billing reduction, off-grid time extension, and predictive energy management for overload protection. The wireless communications network allows the site controller/gateway to act as the gateway for panels and other control modules in the site when a wired communication line would be prohibitively expensive to install.

### IV. Some System Features

### A. Higher Limits on Overload Protection

The degree to which conductor utilization may be increased is limited by safety concerns. One approach for overload protection involves “asking nicely” with smart appliances from the Linux gateway/site controller as a “soft” first layer, then using microcontroller-driven relays to provide a “hard backstop”. The system may use the additional architectural pattern of a local communications network directly between functional-safety microcontrollers.

### B. Site-Level Microgrid Management

Another feature is backup, i.e. managing load, generation, and storage while off-grid, in order to increase the duration and system reliability with which the site is able to operate as a microgrid. The distributed modular nature is well suited for backup applications as for overload protection. Being able to customize energy management to the home may improve control capabilities per unit cost. Being able to coordinate devices throughout the house leads to simpler, cleaner behavior with more reliably good user experience. As with electronic overload control, the site-level integration means that it will be able to provide backup load management with better coordination and fidelity.

### C. Finer Grain Energy Management

On upmarket and/or early adopter sites, homeowners may not be so cost-sensitive and may instead be interested in optimizing for as much monitoring and control as possible. A backup system, for example, might want to exert control over individual kitchen appliances or space heaters. Toward this end, the system's support for distributed modules supports smart outlets which seamlessly integrate with the rest of the energy system, providing further resolution on electricity usage throughout the site.

In addition, a system without site-level coordination would require to run separate connections to the battery to each panel and configure the panels to shed and restore loads separately based on battery SOE/output power, leading inevitably to awkward system behavior. The system with site-level coordination allows the entire site to coordinate to manage battery energy and power.

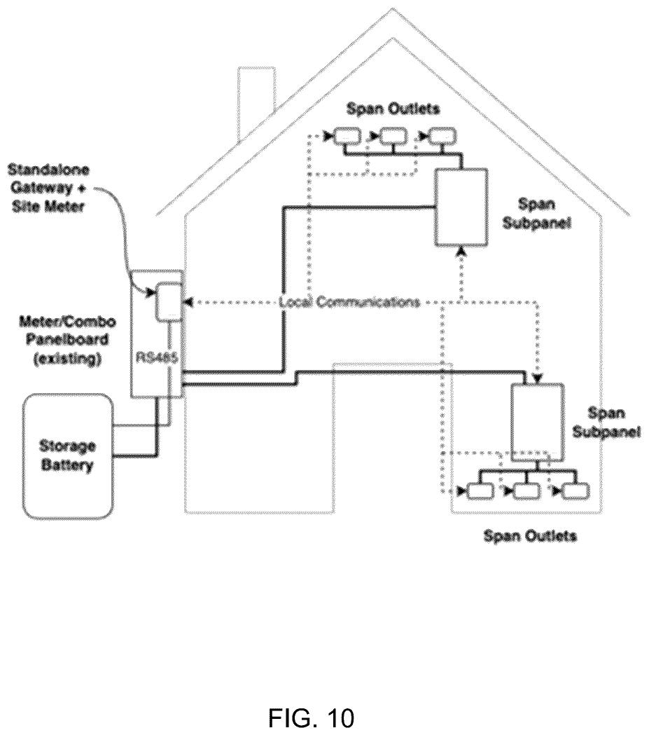

The following is a hypothetical “California-B” house receiving a premium energy management makeover. In FIG. 10, single branch circuits coming off each subpanel are routed to a string of Span smart outlets, each of which can perform plug-level monitoring and relay control.

### D. Multi-Controlled Conductor Sites

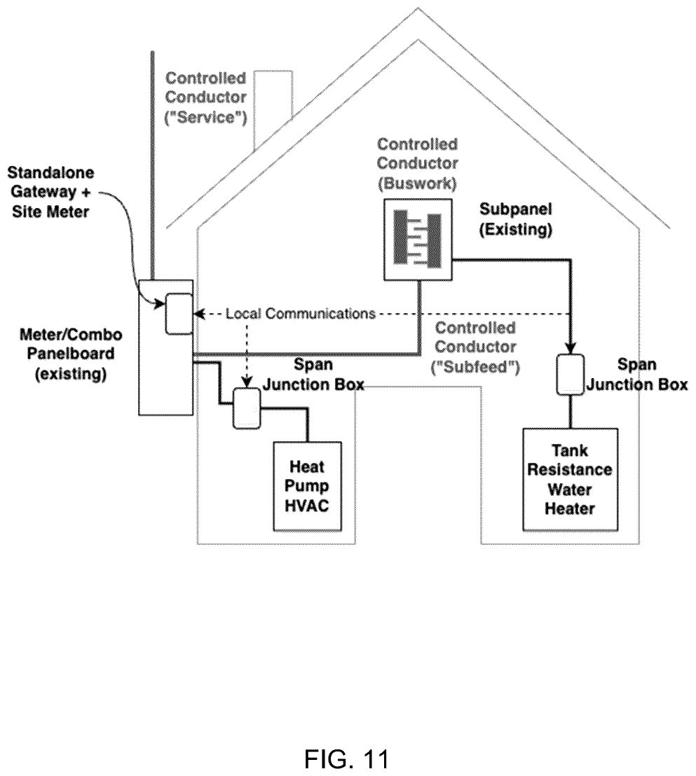

In some sites there may be multiple controlled conductors. The Monitor/Interrupter pattern enables sites to be configured with multiple monitors, each of which maintains its own set of assigned interrupters. See FIG. 11.

### E. Apartments and Condominiums

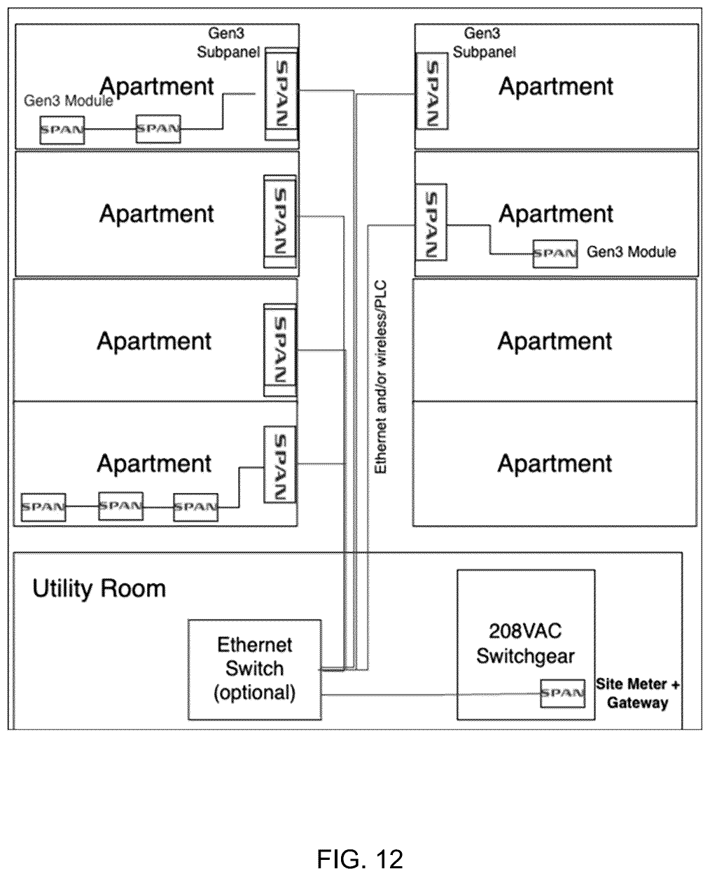

One embodiment of the system panel is designed to operate on single-leg 208VAC input as well as 240VAC input. This allows it to be used for apartment/condominium usage. In some instantiations, such as shown in FIG. 12, each apartment may have a Span subpanel, which may coordinate together into a larger building-wide system to provide building-level electronic overload protection. In some instantiations, Ethernet may be used to communicate between apartments; other instantiations may rely on wireless/PLC “Local Comms”.

### V. Architecture

### A. System Overview

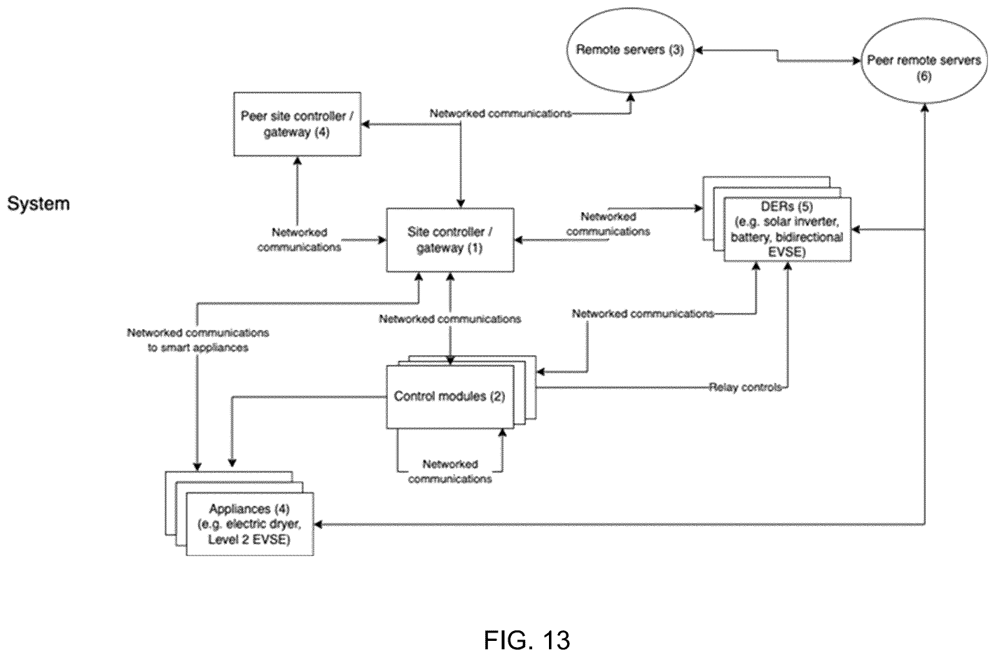

This Architecture section describes the hardware architecture of the system, including basic patterns such as direct MCU-to-MCU communications and the modular chassis. One aspect of the system described herein is modularity. Control modules may be distributed throughout the site and still work together. A single site controller/gateway may serve as an integrated energy management controller which administers all of the devices which generate, store, use, and/or control electricity in the home. See FIG. 13.

The system in FIG. 13 can have the following characteristics and advantages.

Single site controller. A single gateway for multiple devices allows substantial cost reduction over conventional energy management systems, in which every node currently has its own gateway. One computer per site allows reduction in part count for existing devices such as these that homeowners will already be expecting to buy. It also unlocks a new category of low-cost distributed modules such as smart junction boxes that do not have their own Internet connectivity. For sites with multiple panels, a single module which is connected to the local communications network is also connected to a gateway. This module can aggregate information from multiple panels over the local communications network and pass it to the gateway, which can then report information over the external communications network.

Site-level controls functionality. Some functions (“reduce my electrical bill”, “protect my home's service conductor”) play out at the level of the home. Implementing those functions on a single site controller simplifies execution of site-level functions.

Resilience and high-resolution data with locality. Compared to a system without a controller located at the site, by landing a site controller locally, system resilience, e.g. providing full system function and interactivity during network outages, can be improved. Having access to high-resolution data will also make local controllers more powerful and intelligent.

The system in FIG. 13 contains the following devices and components.

Site controller/gateway: E.g., a single or multi-board computer with a computing platform, such as a microprocessor or microcontroller, integrated circuits for communications protocols such as Ethernet, WiFi, Bluetooth, Cellular communications, etc., and the associated connectors and antennas. It may have the following functionalit(ies):
Performs computational tasks such as signal processing, and analytics for the site.
Transfers data from back-end services to the site and vice versa
Receives economic incentives or control signals from utilities or other energy management services to control appliances and DERs at the site
Send signals regarding the site to the utility or other energy management service to inform bulk-system and fleet behavior. Signals and data may include generation capacity, state of charge, expected consumption, etc.
Maintains a connection to cloud resources over the public Internet
   Via WiFi/Ethernet to homeowner router; also has cellular uplink (LTE) as a fallback mechanism
Collects data from and sends control signals to control modules, appliances, and/or DERs over networked communications
Over homeowner Wi-Fi, Span's “Local Comms” network (e.g., a hybrid powerline+RF network), or other local networks such as Thread
   May communicate with smart appliances in the household using open-source protocols such as Matter.
   May use said networks/protocols to exert on/off control over smart appliances, adjust variable setpoints such as the temperature of a smart thermostat or the speed of a variable-speed compressor, set limits on power consumption or proxies for power consumption such as speed, and/or set limits or direct commands for inverter power levels and/or battery charge/discharge rates.
   May also send control signals/collect data from third-party devices via their cloud
      Local network has the following advantages:
         Reduced latency
         Resilience/continued function during wide-area network outages (e.g. natural disasters)
         Ability to collect more/higher-resolution data
Acts as a gateway for control modules, appliances, and/or DERs
Executes control algorithms at site level (see “Multi-Layer Power Flow Controls”)
May include neural network accelerators, digital signal processors, and/or other specialized cores for data processing to support grid services and smart-home features
May perform compression, downsampling, dimensionality reduction, feature extraction, or other forms of data flow volume reduction before transmitting telemetry to the Internet to reduce data transmission costs over the Internet
May include hardware root of trust and/or other embedded security features

Control module: As defined below.

Networked communications: One of many network communications protocols:
UDP/IP or TCP/IP over Wi-Fi, Ethernet, or Thread between site controller/gateway and peer site controller/gateways, remote servers, DERs, appliances, and/or control modules;
Zigbee, Z-Wave, or similar between site controller/gateway and appliances/DERs;
LoRa, Wi-SUN, G3-PLC, G3-Hybrid, Thread, or Wi-Fi between control modules and Site Controller/Gateway (“Local Comms”)

Appliance: Any electrical load in a home, such as an electric clothes dryer, but also including unidirectional AC electric vehicle service equipment (EVSEs).

DER: A Distributed Energy Resource, including distributed generation or storage, such as solar inverters, backup batteries, or bidirectional EVSEs.

Peer site controller/gateway: Another site controller. This may be a peer in the sense of controlling an adjacent site—for example, multiple sites might cooperate to protect an upstream asset such as a distribution transformer—or it may be an upstream controller, for example a “site” controller assigned to monitor a substation.

Remote server: e.g. the backend (running on data centers in a public cloud).

Peer remote servers: In some cases the site controller/gateway may interface with third-party devices (appliances and/or DERs) which do not implement locally available APIs. In those cases, the site controller/gateway may dispatch requests to those devices via the cloud, e.g. by submitting a request to the backend over MQTT which then results in a RESTful HTTP call to the third party's servers which then relays the request back over the Internet to the third-party device.

### B. Communication Networks

One implementation of this system uses three communication modes performing dedicated functions. These networks are an external communications network, a local communications network, and an internal communications network.

External Communications: External communications refers to communications to systems and services external to the system, which usually is also external to the site. This network may be optimized for data throughput and compatibility with various APIs. External communications may be a combination of multiple networks and physical media such as the homeowner's WiFi and direct communications to other products over CAN, RS-485, or other communications channels. Devices connected to external comms may include third party equipment managed by the panel such as residential ESS, HVAC units, appliances, and EVSEs. Services may be back-end first party or third party services such as grid services, data aggregation services, etc. This network may support a variety of products.

The external communications network may have drawbacks that make it unsuitable for certain uses. For example, WiFi, the preferred technology for connecting most devices with homeowners can be unreliable. Home WiFi networks can suffer from interference and packet loss, high latency, and failures due to incorrect or changing network configurations. Additionally, shared buses such as RS-485 or CAN which are exposed to third party products can suffer from changing APIs and incompatibility.

Local Communications: The local communications network may be designed to overcome challenges of the external communications channels. The local communications network may be a closed network between panels that are located at one site (inter-panel communications). However, it is optimized for products that may be located far from each other, for example at different sides of a house, or may suffer from other obstacles present at a site (noise, etc.). Only one module within a panel must be connected to the local communications network.

This network may overcome challenges in the following ways. When a high reliability wired communication, such as ethernet, cannot be installed, it may be implemented using technologies optimized for longer distance but lower throughput technologies such as IEEE 802.15.4 based wireless communications and power line communications. It may be implemented using redundant connections such as ethernet, power line communications, and 802.15.4 wireless communications with automated switching between the communication mediums when one fails. It may be implemented using a mesh network topology which minimizes the effect of one node failing on all other nodes.

Internal Communications: Lastly, the internal communications network is the network between modules within one product (e.g. intra-panel communications). This can be implemented using a low-cost, ubiquitous communications bus such as CAN. In one approach, this is implemented using a common “low voltage spine.” As more modules are added to the panel, the new modules are connected to the spine.

### C. Module Discovery

Discovery is the process by which a module knows it is connected to a Panel Control Module (described below) and vice versa. The Panel Control Module(s) coordinates actions of the control modules. Enumeration is the process by which each control module connected to the Panel Control Module is assigned a specific communication address for future messages. Discovery and enumeration can happen during the initial installation of the product, during upgrades and expansions of the products, or during replacement of a module within a product. Other types of module registration may be used.

In one approach, the process includes coordination of a Panel Control Module and other control modules connected to it via the internal communications bus. Uncommissioned modules may start up in a discovery state and previously commissioned modules can be re-entered into a discovery state via software command over the internal communications bus.

One method of enumeration is to allow each module in a series of modules to add a series resistors to a series connection forming a voltage divider. The final module in the chain connects the chain to electrical ground. The Panel Control Module will apply a voltage at one end of the chain. Each module connected in the series receives a divided voltage level. Modules further in the chain will receive a lower voltage. Additionally, as modules are added, the voltage measured within the Panel Control Module reduces. This way the Panel Control Module can determine how many modules are connected and each module can then deduce its place in the chain by its measured voltage. The Panel Control Module then assigns each module an address via software command over the internal communications bus. The address assignment command is addressed to a specific location in the chain, since each module already knows its place in the chain. Once all modules are assigned an address, the enumeration process is completed.

### D. Control Module

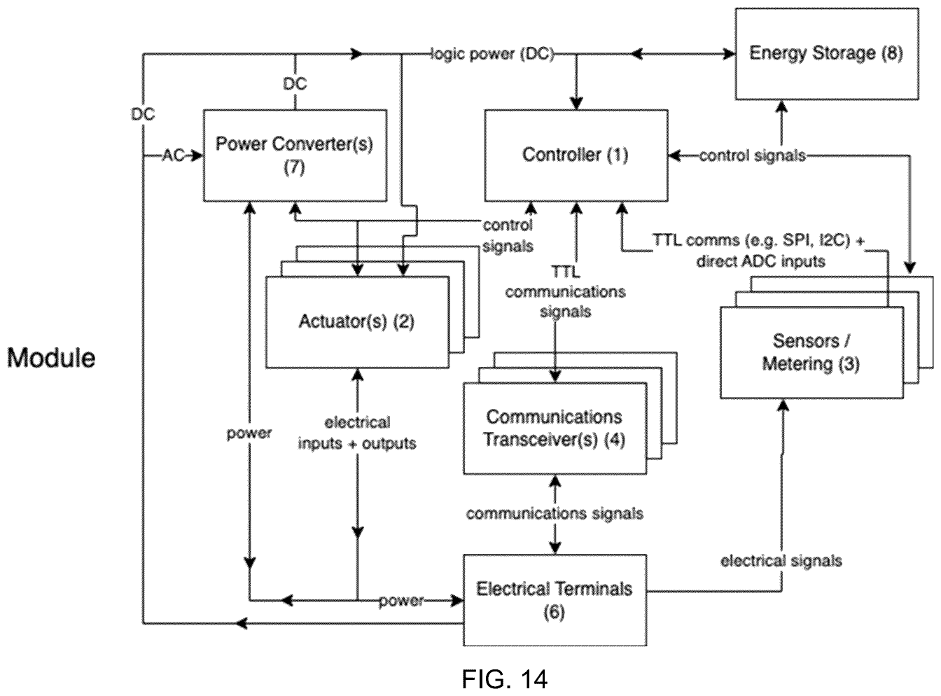

A Control Module is an individual device capable of providing a function such as metering, relay control, or power conversion. Control modules may have multiple functions (e.g. metering and relay control). In some cases, control modules may have only one of sensing, actuation, or conversion capabilities. See FIG. 14.

Control modules include AC chassis modules (i.e., housed in the electrical panel), such as Branch Module, Panel Control Module, and MID/Main Breaker Module. They may also include AC/DC chassis modules, and distributed small modules such as smart outlets, remote meters, and smart junction boxes.

The Control module in FIG. 14 shows the following hardware components, but not all components will be in every control module.

Controller: A microcontroller, DSP, or other such electronic controller. Typically one per module, although some modules may include additional microcontrollers for additional functionality or for redundancy for purposes of safety. Executes control algorithms, reads sensors, manages actuators, and implements communications to other modules and the Site Controller.

Sensor(s): e.g. a current transducer (typically as a current transformer plus burden resistor) or voltage transducer. May include additional chips or modules for sensor processing, e.g. an energy metering ASSP such as the ST Microelectronics STPM34.

Actuator: A physical actuator such as an electromechanical relay which allows control over the flows of electrical power in an electrical distribution system such as the wiring in a building.

Communications Transceiver(s): Transceivers for wired communications protocol and/or wireless/powerline communications means (see “Heads and Tails” below), e.g. a CAN controller+transceiver; an Ethernet MAC and PHY; or a G3-Hybrid modem with a G3-PLC line driver and/or a 900 MHz radio+antenna.

“Spine” Connector: A field-wired connector which carries logic power (e.g. 12VDC), wired Head-to-Tail communications (see below), and other Head-to-Tail digital/analog signals (discussed below under Chassis).

Electrical Terminals: One or more electrical terminals for series (actuation) or parallel (sensing) connection to distribution conductors. May include stabs for plug-on molded-case circuit breakers, lugs, threaded studs, solder pads, small-gauge pluggable PCB connector headers (e.g. Phoenix LPC), or other types of terminal.

The electrical terminals for modules in the panel may have the following. Each module has standard rear-facing busbar mount pads with captive screw fasteners. The Head Module has a series of metering ports, as well as ports for external communications. The Branch Module has 8 circuit breaker stabs. The Main Breaker/MID module has studs to mount either a 200 A main breaker or lugs.

Power converter: This could be a high-voltage to low-voltage converter for producing logic power from distribution conductors, such as a 120VAC-to-12VDC rectifier. It could also be a high-voltage to high-voltage power converter, e.g. an AC to DC inverter (e.g. a photovoltaic solar inverter) or an isolated DC-DC converter (e.g. a photovoltaic solar maximum-power-point tracker (MPPT)).

Energy Storage: An optional capacitive reserve. Used to store energy such that the device can fail safe even if the central power supply fails suddenly.

PMIC: An optional power management IC, shown primarily to indicate the receipt of logic power from the Connector(s).

### E. Chassis

The electrical panel is a set of control modules installed into a chassis at predefined attachment points. Note that not all control modules are co-located in a chassis. The distributed EMS system will include both “standalone” control modules with their own separate enclosures for separate installation as well as “chassis” control modules intended for installation into a chassis.

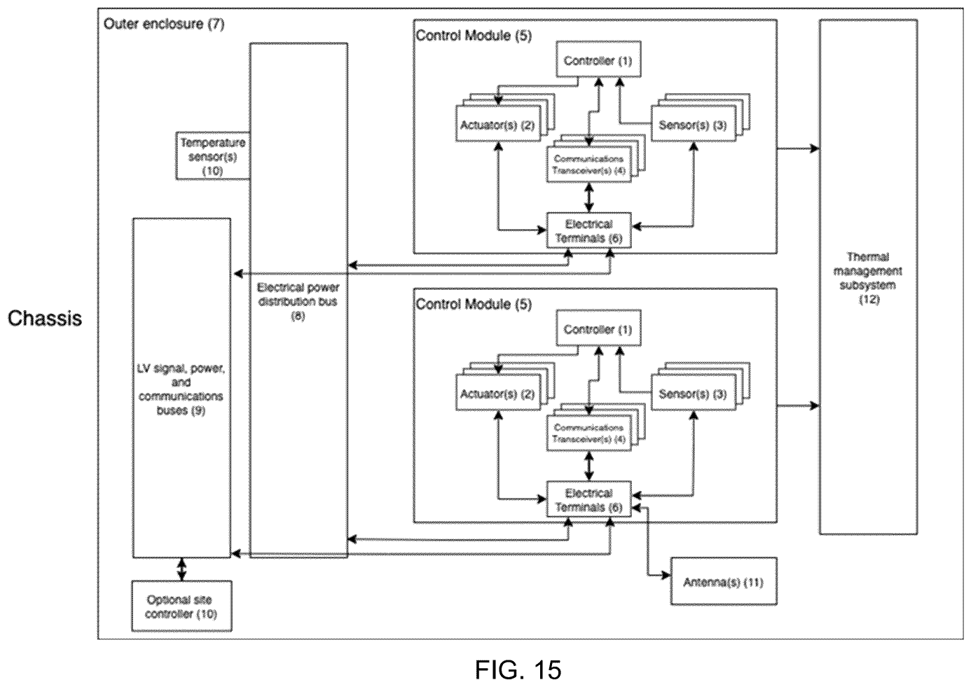

See FIG. 15 for a block diagram of a chassis. A modular chassis will have some benefits to customers and installers, including the following.

Serviceability: If a single component such as a relay fails, it will be substantially less effort to unwire and replace one module than an entire product such as an entire panel, or a monolithic control subassembly. Electricians will appreciate the modular design for this reason.

Customizability: A modular architecture allows customization of panels and similar products to sites, allowing purchasers to select between multiple chassis sizes and to specify which modules are installed. This can either be done using a configurator UI on e.g. the Span website, or with installers actually assembling modules into a chassis on site to build custom panels on the fly.

Hardware upgrades: Even if hardware has not failed, customers may choose to upgrade modules to receive new capabilities (for example to adopt new sensing, safety features, or communications protocols). A modular architecture makes such intervention affordable.

“Power electronics in the panel”: The modular chassis design supports inclusion of different modules, including power electronics.

An electrical panel, such as shown in FIG. 15, may include the following components:

Enclosure: An outer enclosure responsible for protecting against dust and water ingress, providing impact resistance, and performing electromagnetic shielding as necessary. Likely made of sheet metal, although in some implementations it may be composed of plastic, optionally foil-lined for EMI.

Sub-enclosure: The enclosure of a control module contained within the Chassis. Probably plastic. May also be foil-lined. May be protected from water and/or dust ingress using e.g. silicone gasket seals.

Electrical power distribution bus: Electrical bus structure to which modules are attached by e.g. screw bolts.

LV signal and communications buses: The chassis also contains a low-voltage bus (different from the electrical power distribution bus), which may be implemented as a harness or a long PCBA with regularly spaced header connectors. This bus distributes logic power generated by the Logic Power Converter in one or more modules, one or more wired Head-to-Tail communications bus (e.g. CAN, possibly redundant), and one or more digital signals. It serves as an intra-panel communications network between the modules in the panel.

Digital signals may include:
SYNC, a pulse train for synchronizing digital sampling;
FAULT, an active-low digital signal which indicates a hardware or software failure for which modules should fail safe;
OVERRIDE, an active-high digital signal, possibly redundant, which indicates that a user override has been set, for example indicating that all modules should close their relays.

Antennas: The chassis may contain external antennas which connect to installed control modules to increase their RF transmit range.

Temperature sensor: The buswork in the chassis may be monitored for overtemperature, with some means of routing the signal back to one or more control modules (e.g. a temperature sensor may have a pigtail harness which connects to a pluggable PCB connector on the front of the chassis' Head Module).

Optional site controller: A chassis may have a socket into which a Site Controller/Gateway may be installed. This socket may instead be located on the Head Control Module.

Thermal management subsystem: A subassembly of thermal conductors, heatsinks, fins, and/or circulation or ventilation fans which serve to transfer heat from the enclosure.

### F. “Heads and Tails” Communication Topology

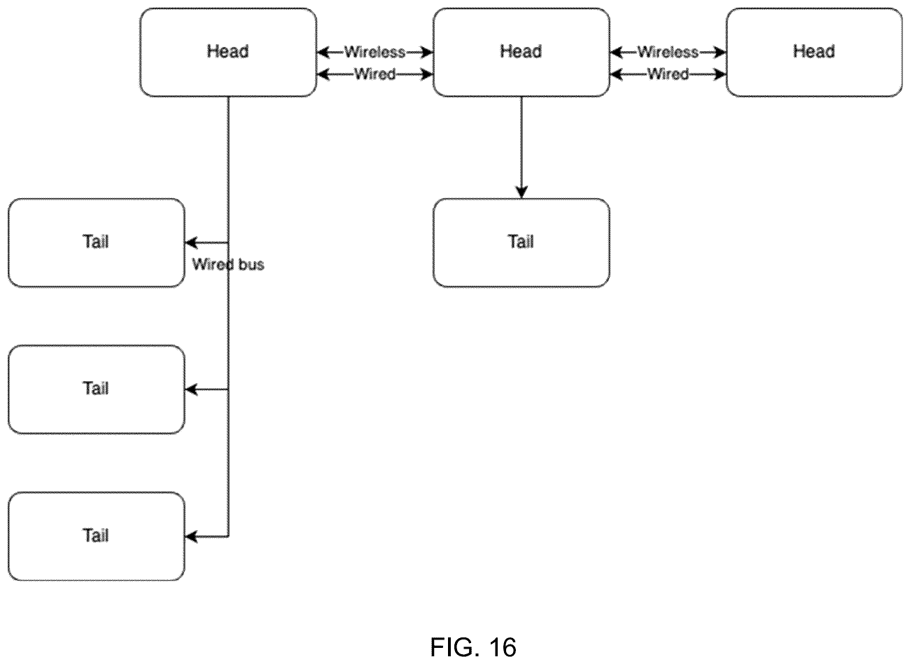

The system may use a two-level communication network topology in which some controllers (Heads) participate in a wireless/powerline network and others (Tails) are proxied into it, as shown in FIG. 16.

A product chassis typically contains one Head and may contain any number of associated Tails. However, some products may contain only Tails, for installation with another product which contains a Head. For example, a 16-circuit subpanel variant may contain only two 8-circuit Branch Modules, which is required to attach to a “parent” panel containing a Head Module via a wired CAN or RS485 connection.

The Site Controller/Gateway may act as a Head (participating directly in the Local Comms network) or a Tail (proxied through a Head). In one implementation, the gateway is a Tail. Note that this architecture is about network topology across heterogeneous link types, and is independent of the controls or messaging patterns implemented on that network.

This approach allows to build multiple modules into a single product with only one transceiver (e.g. radio) per product, saving substantial BOM cost.

Some communications media that may be used for the Head-to-Head “Local Comms” network are limited in available bandwidth. LoRa, notably, only goes up to a theoretical maximum of 27 kbps. Implementing Heads and Tails allows some reduction in required bandwidth, both by reducing the net amount of data that needs to be on the inter-Head medium (e.g. Monitor/Interrupter interactions between a Head device and its own Tail devices) and decreasing message framing overhead (e.g. by combining state payloads for a Head and its Tail devices into a single framed message).

FIG. 16 shows the following.

Local Comms: A high-reliability wireless and/or powerline communications network used for communications between control modules.

Head: A device which has a Local Comms transceiver and uses it to communicate with other Head devices.

Tail: A device which does not have a Local Comms transceiver. Tails are connected by wired communication means, e.g. CAN or USB, to a Head. Communication to a Tail is proxied through its associated Head.

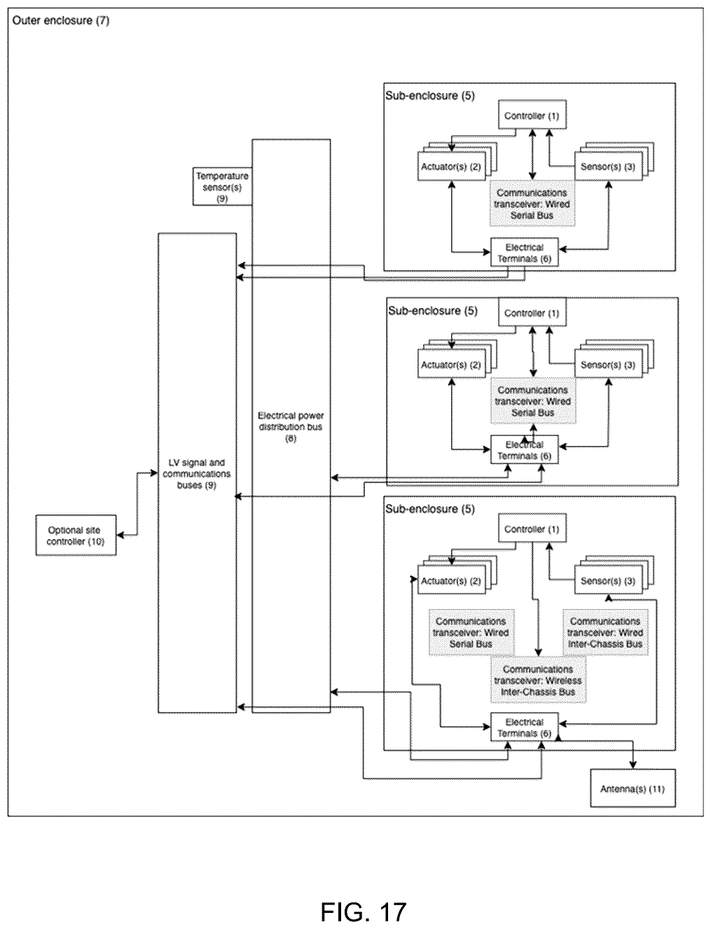

FIG. 17 shows how the “Heads and Tails” pattern may be implemented in the chassis described above. Note that one control module, he “Head Module,” is installed with a wireless transceiver.

### VI. Examples of Chassis Modules

This section and the next section describe example implementations of different aspects of the system. This section includes examples from the electrical panel, including the customizable chassis and control modules that may be field-installed in the chassis. These may be referred to as chassis modules. The next section includes examples of standalone modules (i.e., control modules not installed in the chassis).

### A. The Electrical Panel (Chassis)

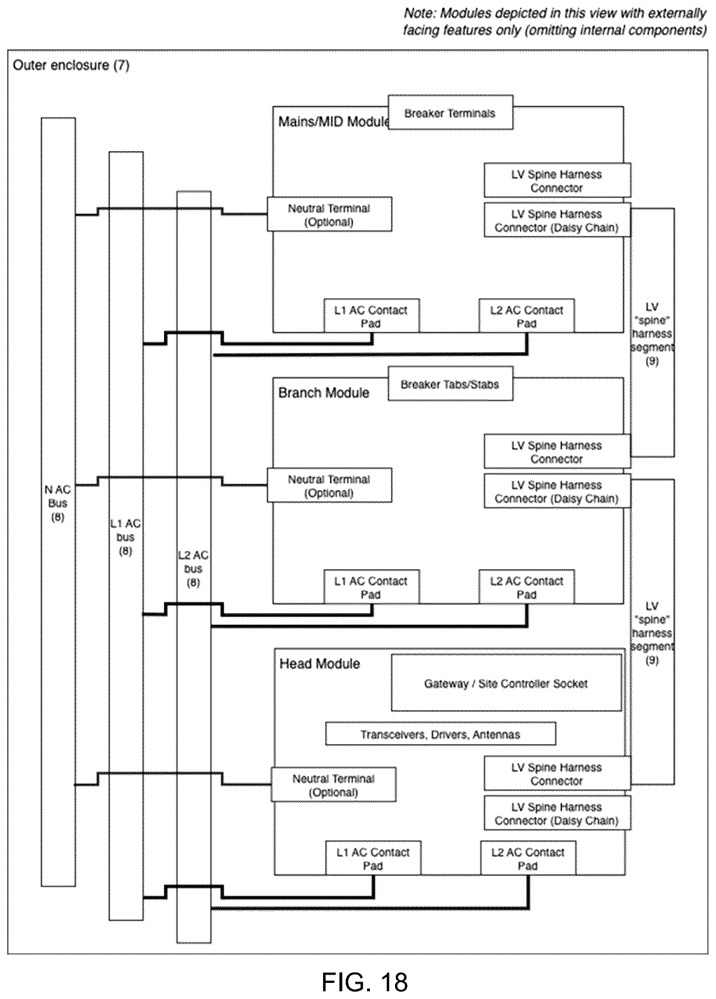

The electrical panel includes a chassis for constructing circuit breaker panelboards. It has modular construction for the benefits of customizability as described above. See FIG. 18. The components shown in FIG. 18 include the following.

Outer enclosure: An enclosure, some instantiations of which may be folded welded sheet metal, deep-draw stamped sheet metal, or injection molded plastic. The enclosure includes a door and a deadfront for restricting homeowner access to field-wired electrical connections. The door and/or the enclosure may include sealing features such as foamed gaskets at mating surfaces for ingress protection. The door may include latching features such as a locking hasp or an integrated smart lock. The door may be constructed of metal or plastic and may have integrated antennas and/or transparency windows for antenna projection, or may have mounting features for such. The door may also include an integrated site controller/gateway.

L1/L2 AC Bus: Busbars at the rear of the enclosure with exposed conductive surface and bolted joint fasteners and/or threaded holes for module termination.

N AC Bus: A busbar or terminal block with regularly spaced screw gate apertures for “pigtail” wire connection to modules.

LV (low voltage) “spine” harness segment: A jumper harness consisting of bundled wires and factory-terminated connectors which plugs into corresponding bulkhead connectors on each module.

L1/L2 Contact Pad: An exposed surface of conducting metal such as aluminum or copper, likely as an element on a busbar, with a bolt throughhole, captive bolt or other mechanism for attachment to a chassis busbar.

Neutral Terminal: An optional terminal for connecting a neutral wire for purposes such as ground fault detection, arc fault detection, powerline communication. May be instantiated as a contact pad, screw-gate, spring clip, pluggable connector, barrel jack, or other such styles depending on required ampacity.

LV Spine Harness Connector: In FIG. 18, the LV (low voltage) signal and communications buses are implemented as a series of jumper harnesses which daisy chain logic power buses and digital signals/communications between modules. These connectors may be located on any installer-facing surface of the module (i.e. front and sides). Connectors may include sealing or terminal position assurance features. In some instantiations, dual parallel harnesses or a loopback from top to bottom may be used for signal redundancy.

Gateway/Site Controller Socket: A socket for installing a gateway/site controller as described above. Note that in other instantiations, the gateway/site controller may be integrated into the door, attached to mounting positions on various internal or external surfaces of the chassis, or may constitute its own module.

Breaker Tabs/Stabs: Electrical terminals to attach miniature circuit breakers. May include features such as tandem rejection tabs.

Transceivers, Drivers, Antennas: Communications hardware as necessary to compose the “Wireless Inter-Chassis Bus” described above.

### B. Branch Module

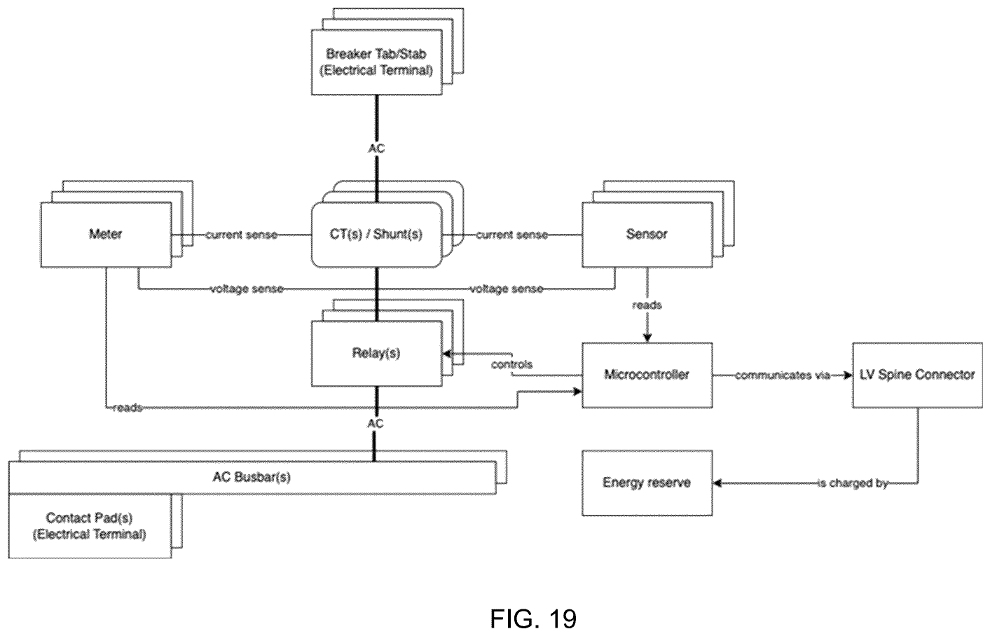

The Branch Module is a basic building block of the electrical panel. These control modules are a modularized section of panel for branch circuit breakers with integrated controls and sensing. See FIG. 19. The components in FIG. 19 include the following:

AC busbar(s): Integrated electrical busbars which distribute AC power from the chassis busbars via the contact pad(s) to individual breaker tabs/stabs or conductors associated to each tab/stab.

Contact Pad(s): An exposed surface of conducting metal such as aluminum or copper, likely as an element on a busbar, with a bolt throughhole, captive bolt or other mechanism for attachment to a chassis busbar.

Breaker Tabs/Stabs: Electrical terminals to attach miniature circuit breakers. May include features such as tandem rejection tabs.

Relay(s): Actuator(s) such as electromechanical relays, each of which is capable of disconnecting and reconnecting one or more of the breaker tabs/stabs to the AC busbar. May also be implemented as high-power transistors.

Meter: Sensor(s) that may include electronic circuits, application-specific integrated circuits (e.g. ST STPM34), microcontrollers (e.g. TI MSP430), or similar devices capable of performing electrical metering to a specific rated accuracy. In some instantiations, some or all of the breaker tabs/stabs in variants of the Branch Module may have meters omitted.

Sensor: Other optional electronic sensor, which may perform sensing duties on branch current and voltage concurrently/electrically parallel to the meter, and which may detect events of interest in the house, and which may communicate or send electrical signals to the microcontroller, e.g. to notify of detected events.

### C. Panel Control Module

The Panel Control Module acts as a hub for the chassis modules installed in an electrical panel. For example, it maintains a registry of the modules installed in the panel. It may provide controls to the installed modules and aggregate data from the modules. The LV spine may be used to communicate with these other modules. The Panel Control Module may also perform Head functions as described above. In some instantiations, the module includes communications transceivers such as e.g. RS485 or CAN for communication to third party devices such as solar inverters, batteries, generators. In some instantiations, the module includes low voltage relays and switches, e.g. to interrupt the 24VAC control line to HVAC systems. In some instantiations, the module includes meters or sensors which accept electrical signals from field wired connectors, e.g. a pluggable connector for externally placed CTs. In some instantiations, meters may measure voltage from the module's contact pads and current from externally placed coverage targets. In others, voltage may be externally provided or selectable between the two by means of e.g. installer-accessible switches or field installable jumpers. Being able to read and send dry contact states, communicate on CAN, and do auxiliary metering directly from the panel itself make the panel well-suited to integration with other third-party equipment.

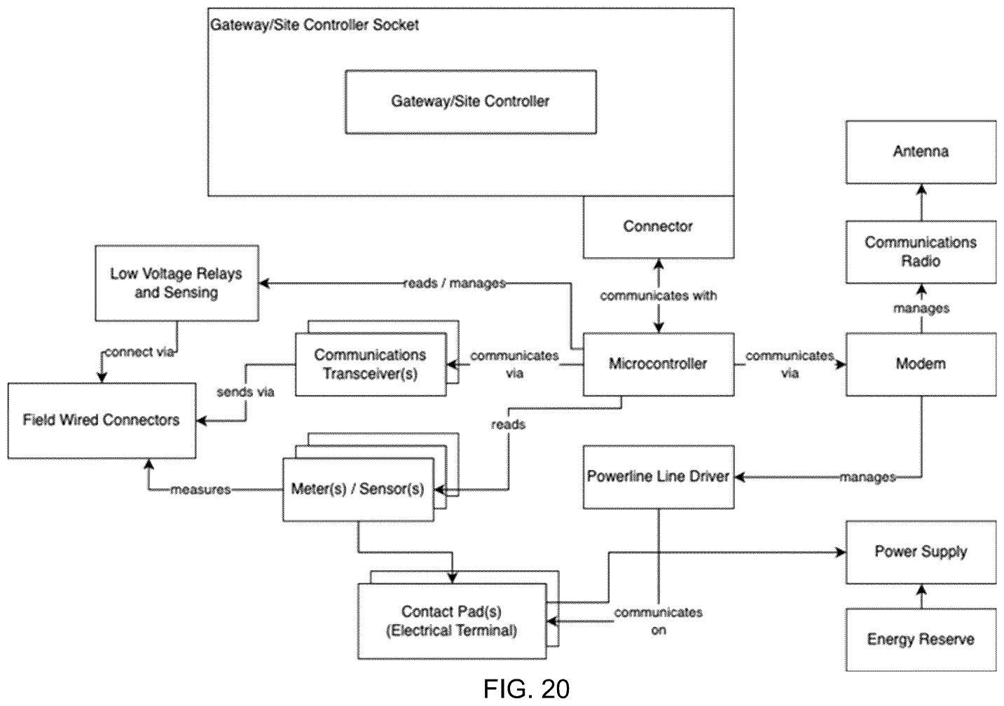

See FIG. 20, which includes the following components:

Field Wired Connectors: One or more electrical terminals for field wiring, including screw gate connectors, spring clip, or pluggable connectors.

Communication transceiver(s): Optionally, transceivers used for communication with other devices such as EVSEs, solar inverters, batteries, appliances, or external sensors. Example instantiations include RS485 transceivers (e.g. for Sunspec Modbus to solar inverters) and CAN transceivers (e.g. for communications to storage batteries).

Meter(s)/Sensor(s): Electrical meters and other electronic sensors which measure AC voltage at the contact pads.

Powerline Line Driver, Modem, Communications Radio, Antenna: Hardware for supporting Head functionality, i.e. wireless/powerline communications. In FIG. 20, a modem is used which manages both an AC line driver for powerline communications (e.g. HomePlug Green PHY or similar), and a radio (e.g. Zigbee). In other instantiations one or the other may be used and/or the microcontroller may manage them directly rather than being mediated by a modem.

Power Supply, Energy Reserve: A power supply capable of generating DC logic power from AC via the contact pads and distributing it to the LV spine, and a source of energy (battery, capacitor, or similar) either before the power supply (i.e. storing rectified AC) or after the power supply (i.e. storing logic-level DC), which can be used to continue providing power to the module and (in some instantiations) other modules on the LV spine. The power supply and energy reserve are not depicted as wired to anything and should be understood to be capable of powering all of the electronic/electrical components in the module. In some instantiations, certain components may be not powered or selectively powered to allow downsizing of the energy reserve.

### D. Main Breaker/MID Control Module

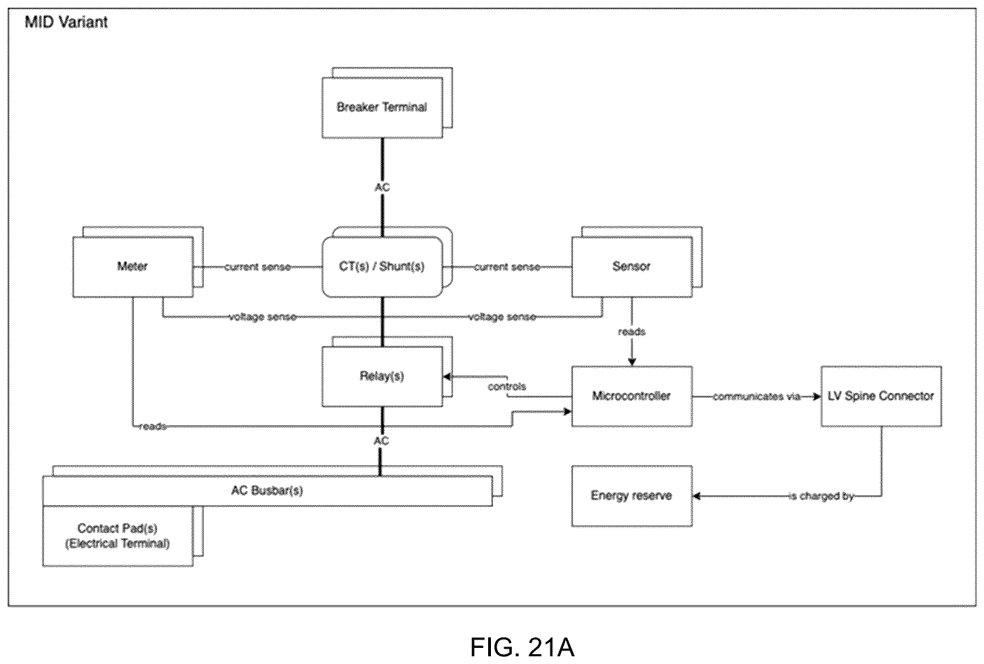

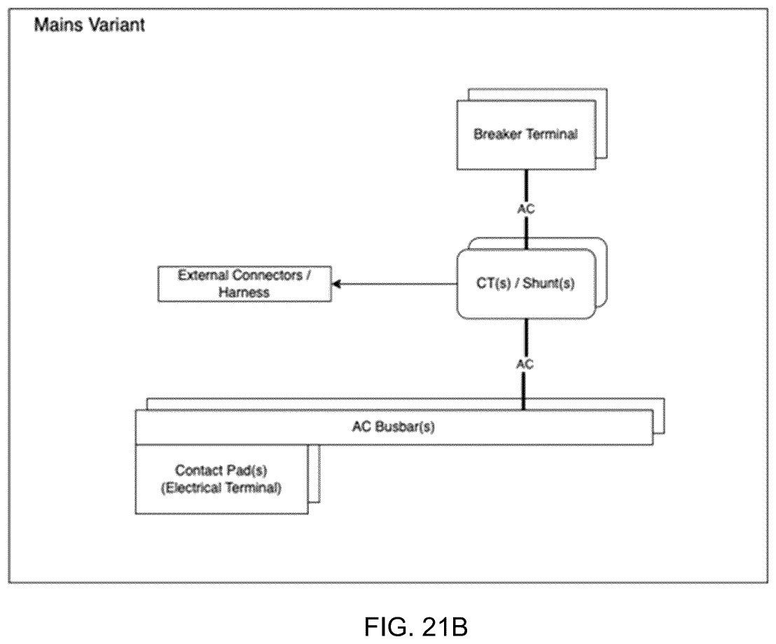

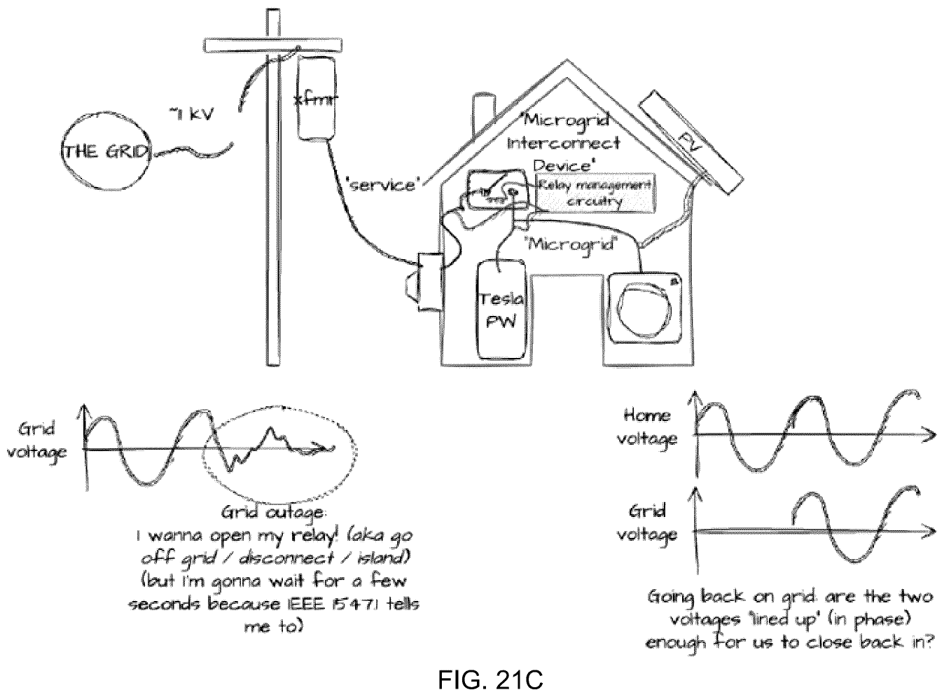

The Main Breaker/MID Module supports feeder/service entry into the panel from a single main breaker. MID stands for microgrid interconnect device, which allows a microgrid (such as the home power grid) to be connected and disconnected from the main grid. In some instantiations, such as depicted below in the Mains Variant, the relays may be removed and electrical measurement may be performed by running a harness to the field-wired metering inputs on the Head Module in order to reduce cost. The Mains/MID module may support the use of lugs instead of a main breaker in installations where an upstream breaker is already present. See FIGS. 21A and 21B, which show a MID version and a Mains version. FIG. 21C shows example operation of the MIDS.

### VII. Examples of Standalone Modules

This section describes examples of standalone control modules.

### A. Standalone Gateway+Site Meter

The standalone gateway+site meter is a standalone module with its own enclosure. This module may include a “Head” microcontroller implementing wireless/powerline communications as above. In some instantiations the “Head” microcontroller may be removed and the applications processor in the gateway/site controller may perform those functions directly. Field wiring terminals provide a means of connecting external CTs and voltage sense lines to the module.

In some instantiations this may be delivered without the gateway, i.e. just as a standalone site meter.

Packaging this into its own enclosure will be useful as a source of premises metering and a way of protecting the incoming service and/or internal buswork in pre-existing main panels.

This configuration can be used to enroll a site into an energy management contract offered by the utility or other service at a low cost. The gateway+meter can be used to send and receive data and controls between the utility and controllable loads and sources at the site. This can be used for scenarios such as shedding load based on economic incentives.

This configuration can also be used to control home loads and sources based on optimization, inference, and learning algorithms. This can be used to provide optimized behaviors even without direct control inputs from the user or grid. For example, it can be used to extend battery life in a microgrid scenario or provide time of use cost reduction even without enrollment in a utility incentive program. This can be useful for emergency preparedness, cost reduction, emissions reductions and other use cases.

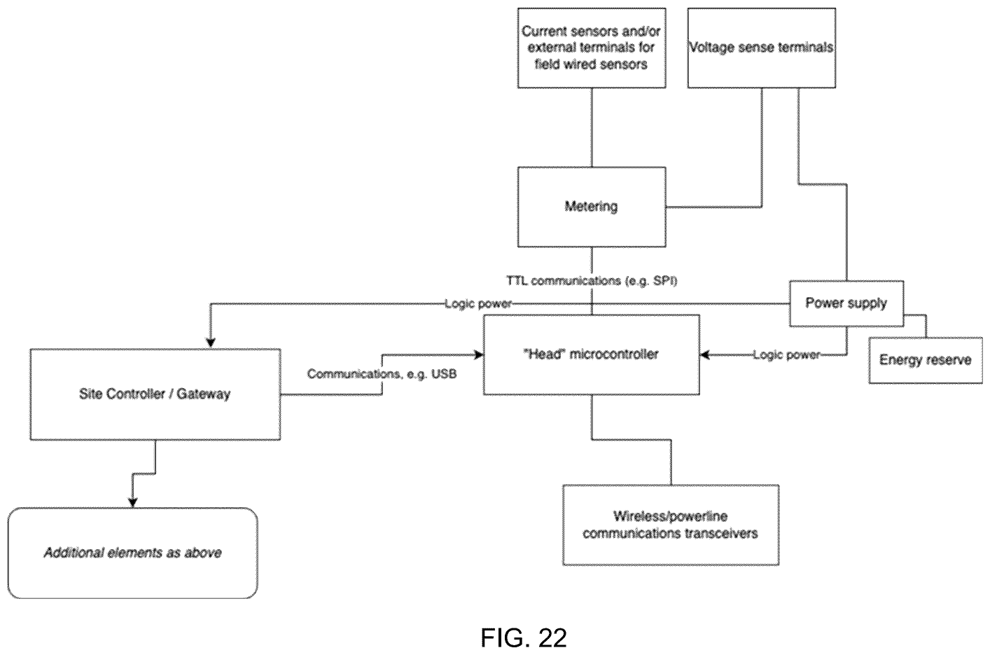

See FIG. 22.

Standalone modules that perform similar functions to a Panel Control Module, e.g., maintaining a registry of other installed modules, may be referred to as Microgrid Control Modules.

### B. EVSE (Electric Vehicle Service Equipment) Module

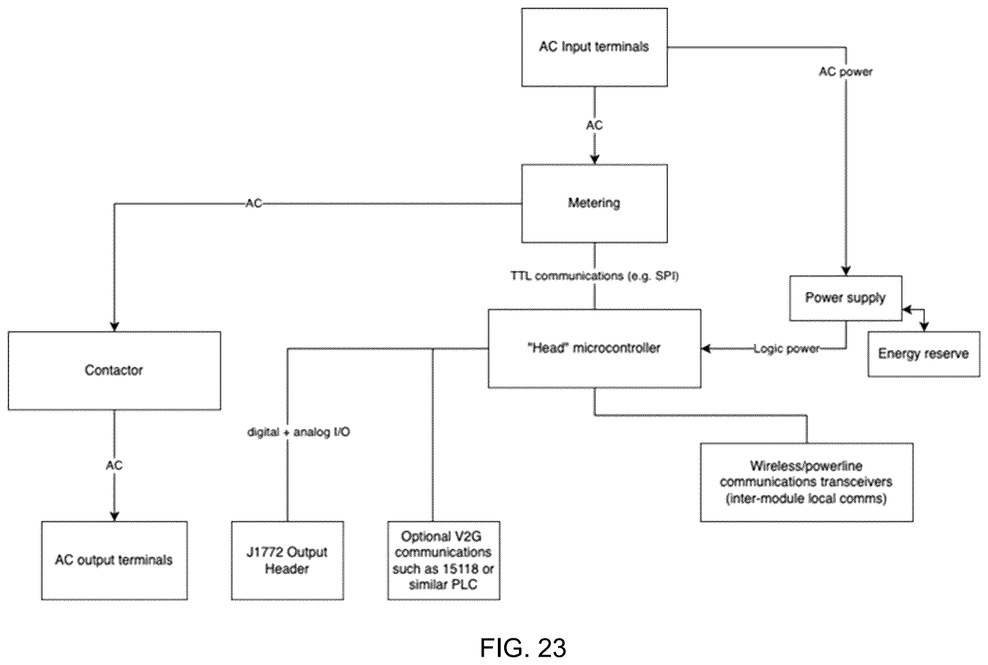

The EVSE control module may be configured as a Head module in this platform, as shown in FIG. 23. It may also be configured as a Tail module.

### C. Smart Junction Box

A smart junction box could be installed in-line in series with existing or new wiring to provide metering and control for a specific, permanently wired appliance or circuit. For example, an installer adding a new heat pump might install a smart junction box upstream of the compressor to allow Span to turn off the compressor during overload events without requiring a main panel upgrade. This module will allow appliance-level control for appliances that share branch circuits. It will also allow branch-level control for branch circuits that do not land in Span panels, for example in retrofit sites with existing panels that are not being replaced. See FIG. 24.

This could take the form of a small sheet-metal enclosure with screw cover and punchouts for conduit entries, screw or spring terminals for wiring, and relay control, metering, and controller in order to be able to participate in electronic overload protection. Depending on product need and thermal/size constraints, different instantiations of this module may serve as either Head or Tail modules; hence the wireless/PLC transceivers used to participate in Local Comms are depicted as optional in FIG. 24.

Note that in some instantiations this same module may be integrated into third-party appliances or distributed energy hardware, possibly sharing the same enclosure.

### D. Smart Outlet

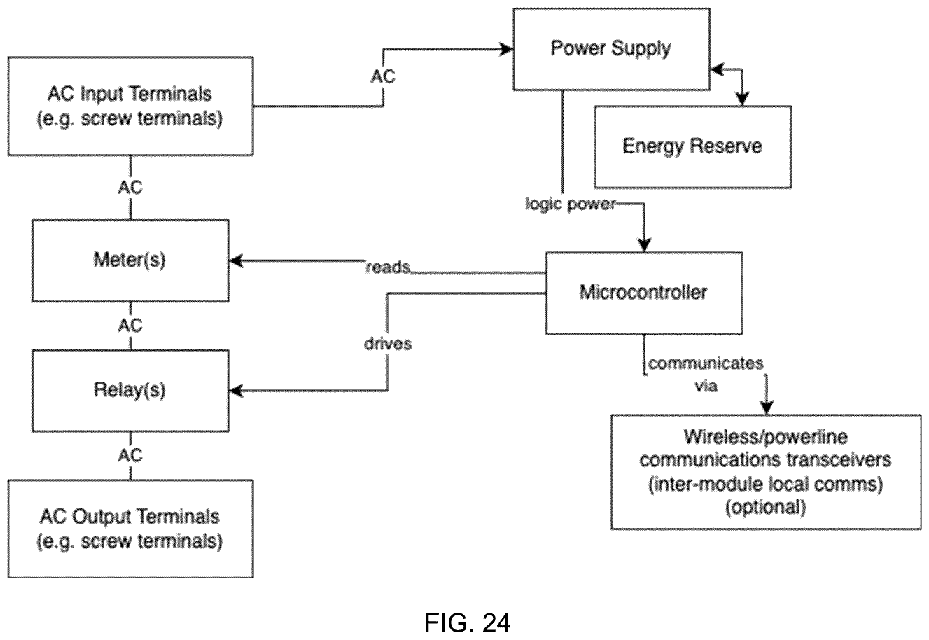

For plug loads, a standalone module similar to the junction box but which serves plug outlets rather than hard-wired appliances may be used. See FIG. 25.

This could take the form of a small sheet-metal enclosure with screw cover and punchouts for conduit entries, screw or spring terminals for an inlet, and relay control, metering, and controller in order to be able to participate in electronic overload protection.

As with the junction box, depending on product need and thermal/size constraints, different instantiations of this module may serve as either Head or Tail modules; hence the wireless/PLC transceivers necessary to participate in Local Comms are depicted as optional in FIG. 25.

### VIII. Controls

This section describes various control and behavioral patterns that may be present in the modular system described herein.

A. Multi-layer power flow controls

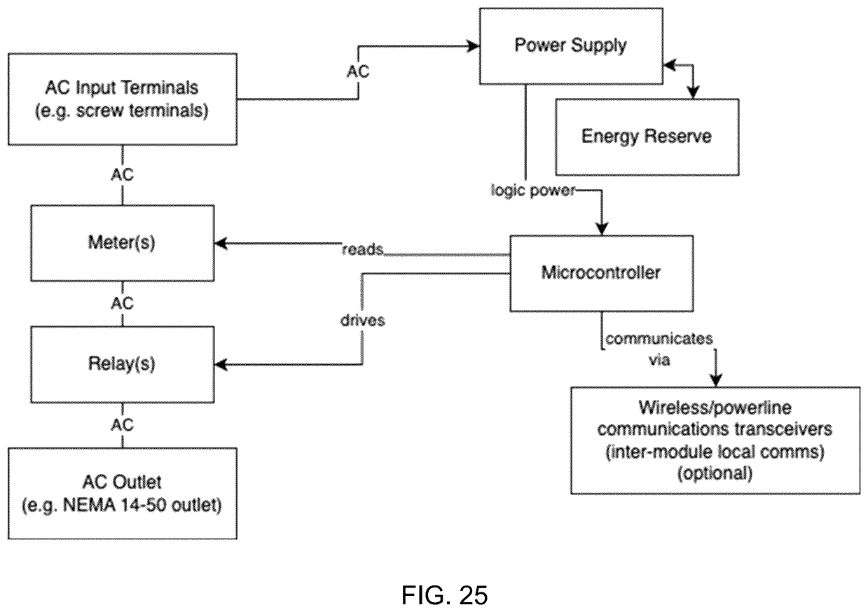

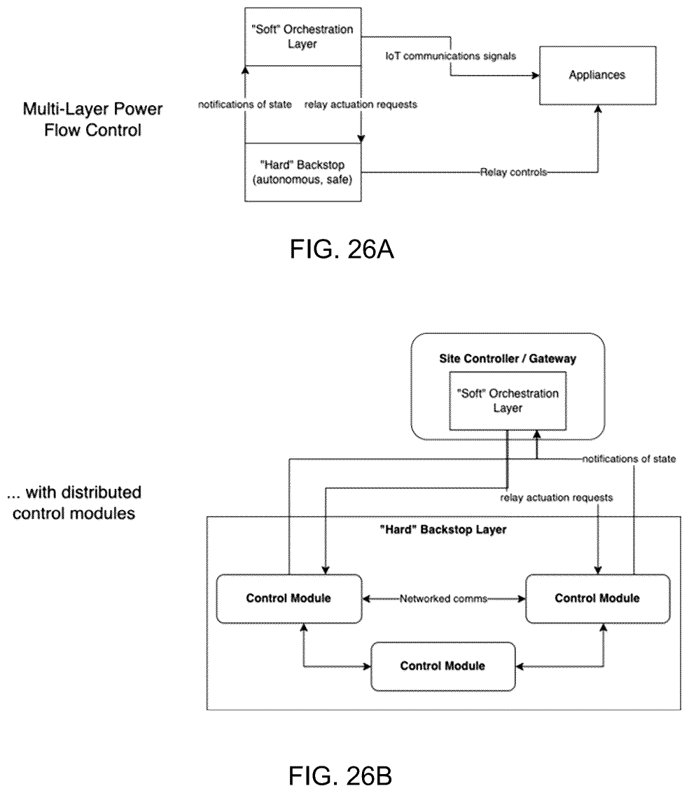

The system may implement a “Multi-Layer Power Flow Control” pattern, as shown in FIGS. 26A and 26B. In FIG. 26A, this function is implemented on a single microcontroller, for example as a set of RTOS tasks. In FIG. 26B, this is performed by a set of control modules which interact directly with one another using networked communications. In both cases the “hard backstop” layer acts autonomously to implement power control/overload protection. The Site Controller may only enable/disable and apply configuration to the layer.

Smart local controllers with predictive and data analytical capability will be able to do better energy management than lower-level controllers executing e.g. simple threshold-based state machines. The right local intelligence may be able to both generate more demand elasticity—for example, by depleting more of hot water for demand-response events during a time of day/week when the lights in the house are off and when it is known from typical lighting use patterns that the user will not come home for another few hours-and to reduce the obtrusiveness of the load management.

FIGS. 26A and 26B includes the following components.

“Hard backstop” layer: A layer implementing guaranteed load shed in case of excursions. Control modules in the hard backstop layer are equipped with actuators such as electromechanical relays which can provide guaranteed reduction in controlled conductor current. Actuators may be verified to be intact using self-test functions in hardware. The hard backstop layer may be verified for the purpose to a functional safety standard, and is likely implemented on real-time controllers with real-time operating systems (RTOS). In some implementations hard backstop devices may also attempt load reduction using IoT communications before interrupting current.

“Soft orchestration” layer: A layer implementing more sophisticated energy management functions. This may include advanced data analytical means, e.g. decision trees (e.g. xgboost), neural networks, prediction, and disaggregation algorithms (i.e. for differentiating multiple appliances on a conductor). It may also act on more varied inputs, e.g. user occupancy, use patterns including e.g. differences in use between weekdays and weekends, appliance state (e.g. “dryer is running”), machine-learned appliance attributes (e.g. “dryer usually runs for 30-45 minutes”), predefined rules about how to manage specific makes/models/types of appliance, etc. Control module: As described above.

IoT communication signals: The “soft” orchestration layer may send signals to appliances over Wi-Fi, Thread, Zigbee, Z-Wave, or other IoT communications protocols, possibly using Matter as an application layer protocol, to request that appliances change state or reduce power.

Notifications of state: The “hard” backstop layer may be configured by the device(s) in the “soft” orchestration layer, but its state (e.g. timers, I2t accumulators, overload flags, etc) cannot be directly modified by said “soft” device(s). Instead, “hard” backstop layer devices report their state as a read-only stream of messages to the “soft” layer, which can then take it into account (e.g. to try to shed an appliance using an IoT communications request before the “hard” backstop layer sheds it with relays).

### B. Software-Defined Essential Load Management

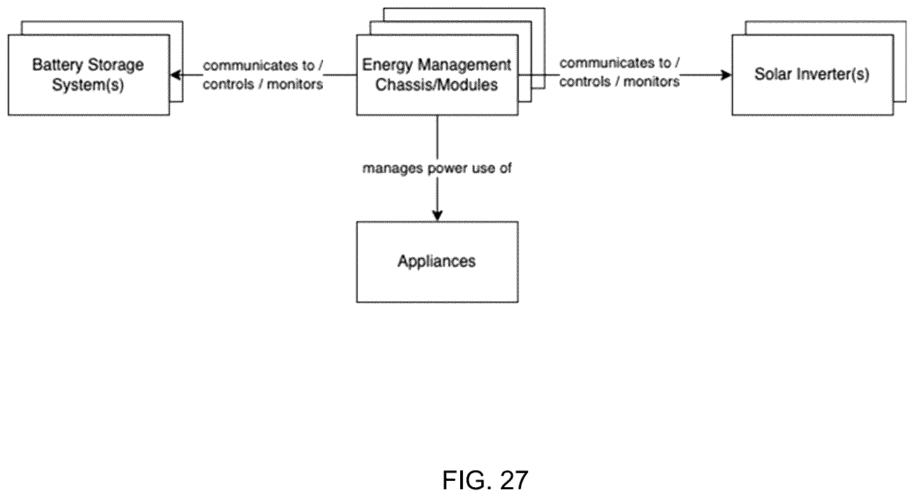

Software-defined essential load management is an important value proposition. Essential load subpanels are additional circuit breaker panels added downstream of backup storage inverters to allow users to select what is powered in an outage. Essential load subpanels are a design alternative to whole-home backup; for many consumers, whole-home backup is too expensive, requiring e.g. two Tesla Powerwalls instead of one, and it is preferable to buy an undersized storage system and power only specific loads. Customers may dynamically select what is powered, and/or to be able to do so algorithmically in order to advance customer goals—for example, offering “infinite backup”. The system described herein can offer software-defined backup at the site/building level. See FIG. 27.

Some advantages may include the following. Loads will be able to land in any panel, not just the one attached to the battery (since load management occurs at site-level, not product-level). The system will be able to integrate with generators using added dry contacts in the Panel Control Module. It will be possible to do appliance-level load shed and metering for appliances that share a branch circuit.

FIG. 27 includes the following components.

Energy Management Chassis/Modules: Modules, separate or co-located in chassis, coordinating over inter-device communications as described above to perform backup optimization. Through use of modules with the appropriate communications transceivers, such as e.g. RS485, CAN, and Ethernet transceivers in the Panel Head Module, the combined system communicates with battery storage and solar generation systems (first-or third-party). The system may monitor battery state of charge, state of energy, state of health, or may directly monitor parameters like battery voltage and current. The system may measure appliance/electrical load characteristics such as voltage and current. The system may perform inference or prediction on those parameters in order to automatically manage appliance/load power usage or make usage suggestions to homeowners in order to extend backup time, maximize revenue generation, or other such functions.

### C. Monitor/Interrupter Pattern

The system described herein can be designed to provide overload protection for any conductor in a building, presuming the right set of hardware modules are installed in that building. This generic pattern is referred to as “monitor/interrupter”.

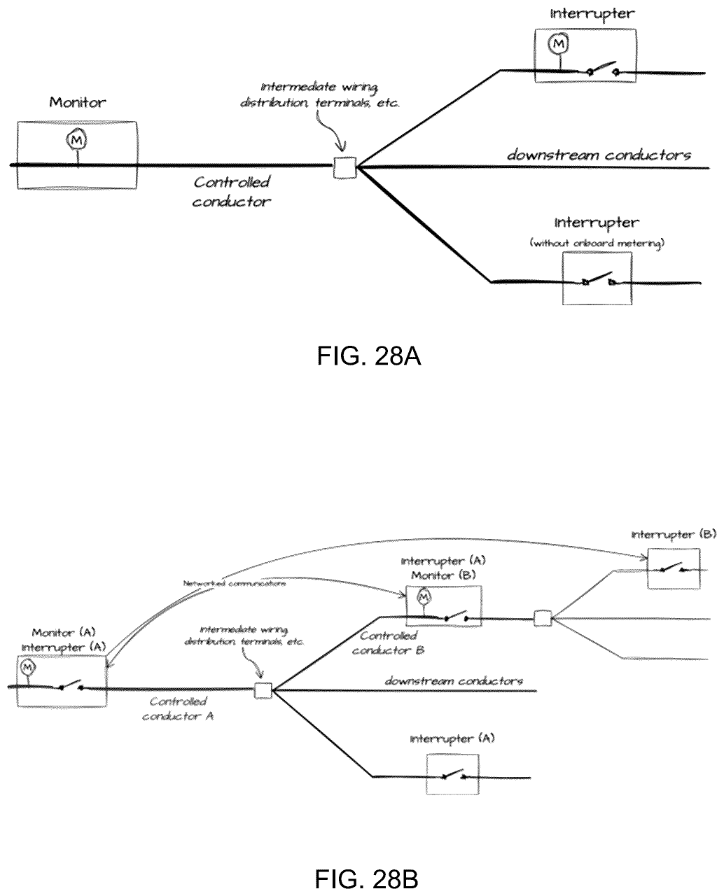

In the “monitor/interrupter” pattern, for any given controlled conductor, control modules may be assigned roles in the protection of that conductor. Some control modules may be assigned to Monitor the conductor; others may be assigned as Interrupters. See FIG. 28A.

Control modules may perform multiple roles simultaneously for multiple controlled conductors. For example, a control module may serve as both Monitor and Interrupter for a controlled conductor. A control module may also serve as Monitor for one controlled conductor and Interrupter for another. Control modules may also serve as Interrupter for multiple controlled conductors at once. See FIG. 28B.

Roles are configured by the Site Controller/Gateway during the installation process, acting on metadata provided by the installer. During configuration, Monitors are given sufficient metadata to address messages to their assigned Interrupters (as URIs, IP addresses, UUIDs, or similar) and may be given metadata to verify messages from their assigned Interrupters (e.g. public keys). Interrupters may similarly be given metadata about their assigned Monitor.

This control pattern enables the multi-flow power flow control pattern shown above.

In addition, there may be many different types of conductors to protect: the service conductors to a house; the buswork inside a panel (either one manufactured by Span or a third-party panel that is monitored); possibly even neighborhood distribution wires and/or transformers. It is quite conceivable that a house will need multiple conductors protected at once (for example the service and a garage subfeed with multiple EV chargers on it).

By making systems able to flexibly protect many different types of wiring, and by allowing installers to configure on site which conductors are protected and how, this can maximize the number of use cases addressed, and increase reach and impact. By defining so with generic behavioral patterns, flexibility can be achieved with a single, generic, functional safety-verified codebase, and feel confident that it is applicable across heterogeneous site topologies and install configurations.

FIGS. 28A-B include the following.

Controlled conductor: A conductor that the panel is responsible for protecting from overload.

Monitor: A role in which a control module is responsible for monitoring the current through a controlled conductor and alerting downstream Interrupters of the need to shed load. As discussed below, the Monitor may do so by transmitting information about the instantaneous current through the controlled conductor, or it may do so by specifically sending requests to shed and restore loads.

Interrupter: A role in which a control module is responsible for reducing the current through the controlled conductor by physically interrupting the flow of current through use of an integrated series electromechanical relay or similar (e.g. by tripping a bimetallic-strip circuit breaker, opening a solid-state circuit breaker, or disabling an H-bridge). Interrupters may be capable of reducing current as well as interrupting it; for example.

Networked communications: For example, communications either directly across the wireless/powerline communications means (“Head to Head”) or proxied between Heads/Tails via Head nodes.

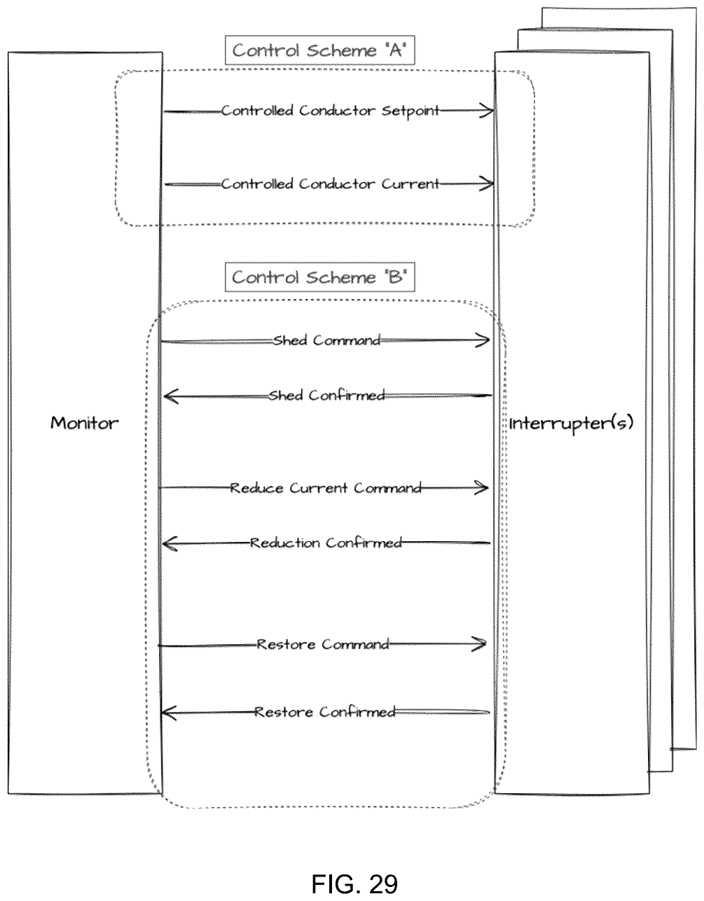

The Monitor and Interrupter may interact using one of two control schemes (designated “A” and “B” in FIG. 29). Other control schemes may also be used.

“Control Scheme A”: Interrupters know their own shed priority and decide when to shed based on a Controlled Conductor Setpoint (the current rating of the conductor or other threshold at which to trip) and Controlled Conductor Current readings sent periodically by the Monitor.

“Control Scheme B”: The Monitor maintains a central record of shed priority for each Interrupter and decides which Interrupters should shed and when based on its own current measurements. It realizes this with a set of Commands to Interrupters to shed, reduce current, or restore.

### D. Failsafe Contracts

To prevent unsafe conditions in case of communications loss, control modules will either open circuits preventatively or enter a failsafe behavioral mode in which their collective behavior preserves the guarantee of overload protection without depending on communication. This latter pattern is preferable, to avoid unnecessarily turning off customer loads.

Modules in this system thus implement a pattern referred to as “failsafe contracts,” in which each Interrupter can be assigned predefined behavioral modes in case of communication loss.

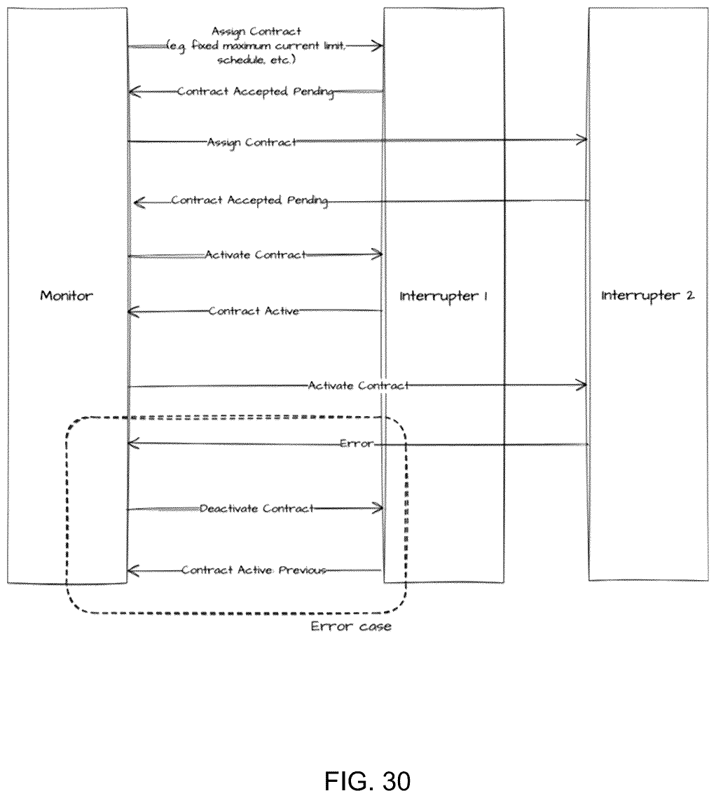

FIG. 30 shows a sequence diagram for configuration of a failsafe contract. Some specificities to note in the diagram. The sequence diagram shows a two-step process to implement a failsafe contract (“Assign”/“Activate”). In some implementations this could be done with a single messaging step to assign and activate, or with an additional “Persist” messaging step which reads out and verifies the active contract from each Interrupter (temporarily enabled in this pattern), then instructs interrupters to continue executing them indefinitely.

The sequence diagram of FIG. 30 shows the Monitor assigning contracts and Interrupters executing on them. The exact role of assignment does not matter for the pattern. In other implementations the Interrupters could agree amongst themselves using a consensus algorithm, or a third node such as the Site Controller/Gateway could assign them.

FIG. 30 includes the following data structures.

Contract: A serializable data structure (e.g. Protobuf message) encoding predefined behavior to execute in case of communications loss. It may be one of the following;
A fixed limit, e.g. limiting a particular subfeed to 80 A total.
A schedule of fixed limits. For example an EV charger which is only used at night might be assigned “OA limit from 8 AM to midnight, then 40 A from midnight to 8 AM”, in order to free capacity for other systems during that period.
Instructions for how to interact with other Interrupters, including fallback cases for if communication is not possible—for example “if you can communicate with this Interrupter, please share 100 A of capacity, otherwise observe a fixed limit”.
Other such rule sets for which, if the assigned rule sets are observed correctly by each Interrupter, the controlled conductor current will be verifiably limited below the Monitor's setpoint.

FIG. 30 includes the following messages.

Assign Contract: The Monitor sends a message representing a failsafe contract (or configuration thereof) to an Interrupter.

Contract Accepted, Pending: The Interrupter acknowledges receipt of the contract but waits until an Enable command to implement it. By sending this, the Interrupter vouches that it has saved the terms of the contract into non-volatile memory and, if that device's non-volatile memory is ECC memory, that the ECC is correct.

Activate Contract: Once all Interrupters have acknowledged the contract and are ready to implement it, the Monitor sends a command to enable the contract. Preferably implemented as a broadcast so as to ensure that communications are not lost.

Contract Active: An Interrupter acknowledges the Activate Contract command and confirms that it will observe the contract. The Interrupter may begin executing the contract relevant to that contract in a “shadow” mode in which its programmatic representation is executed but loads are not actually shed so long as communications with the Monitor remain intact. The Interrupter may return an Error if that code fails to execute. Interrupters may also simply set a flag in memory which causes the contract code to begin executing when communications are lost.

Error: Any error in accepting or activating a contract. For example:
An Interrupter might respond with Error to an Assign Contract command for a contract type that is unsupported on that device (e.g. if a Monitor attempts to assign a schedule contract to a device which does not have a real-time clock);
The implementation of a particular type of failsafe contract on a particular Interrupter might contain a software bug that presents at runtime and results in a process/task crash. That Interrupter begins executing the contract task upon receiving an Activate Contract. When the task crashes during its first iteration, the Interrupter detects it, falls back to its working implementation of the previous contract style.

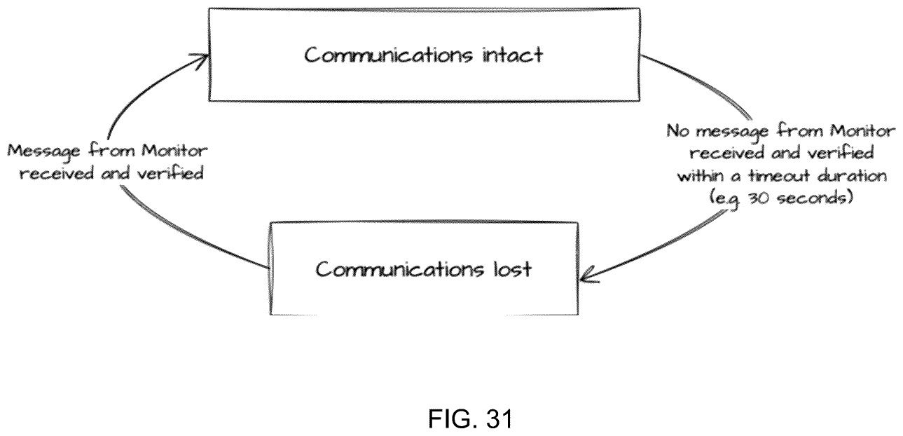

Interrupter timeout: With the contract thus in place, nodes implement communications timeouts using a state machine or equivalent model behavior, for example as shown in FIG. 31.

Communications intact: A state in which the code representing the failsafe contract is either run in “shadow mode” or not run at all. An Interrupter will shed loads upon request from the Monitor.

Communications lost: A state in which the code representing the failsafe contract is run. Interrupters shed load according to the logic encoded in the failsafe contract, using current measurements available to the device in question. (n.b. if the device becomes unable to make those measurements, it will fail safe.)

“Message received and verified”: A message is received and its contents are verified according to one of various means:
The CRC or other ECC may be verified.
A cryptographic signature may be verified against the Monitor's public key.
A sequence number may be verified to be e.g. one greater than the previous.
A timestamp may be checked for recency against the Interrupter's clock.

### IX. Example Implementations

This section describes an example implementation of a modular architecture for managing site-level electrical power distribution.

### A. Modules

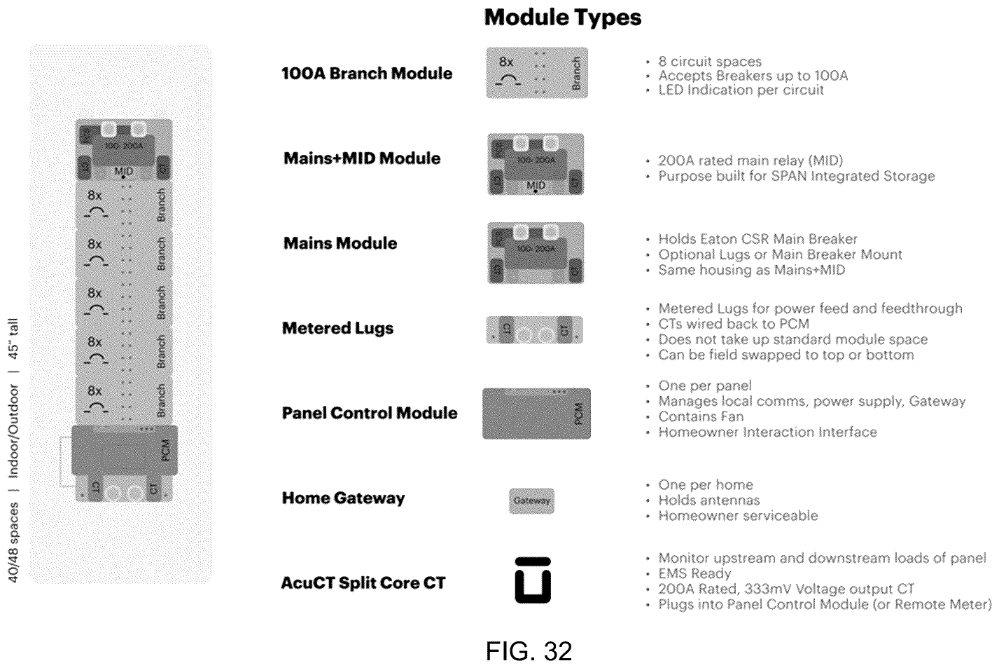

The lefthand side of FIG. 32 shows an electrical panel constructed from various modules. The righthand side of FIG. 32 shows each of the individual chassis modules, some of which are described in Section VI. The branch module is a basic building block for panels and the overall system. In this example, the branch module includes space for 8 monitored and controlled home circuits. For a typical home without battery storage, a Mains module provides a place to land the main feeders in the panel with overcurrent protection and a disconnect. The Mains+MID module is the same but also holds a MID to allow the panel to isolate itself from the grid. For panels where no Mains is required, a Metered Lugs module provides a way to pass electricity into or out of the panel, with metering. The Panel Control Module manages control of the panel, may provide local compute for tasks such as powerup, and may provide power to all the other modules. It may also include some user interface to provide users with the ability to interact with and/or override the system. The Home Gateway may act as a site controller. It may aggregate all the data from multiple panels (and devices outside of panels), make site-level decisions and report to the cloud.

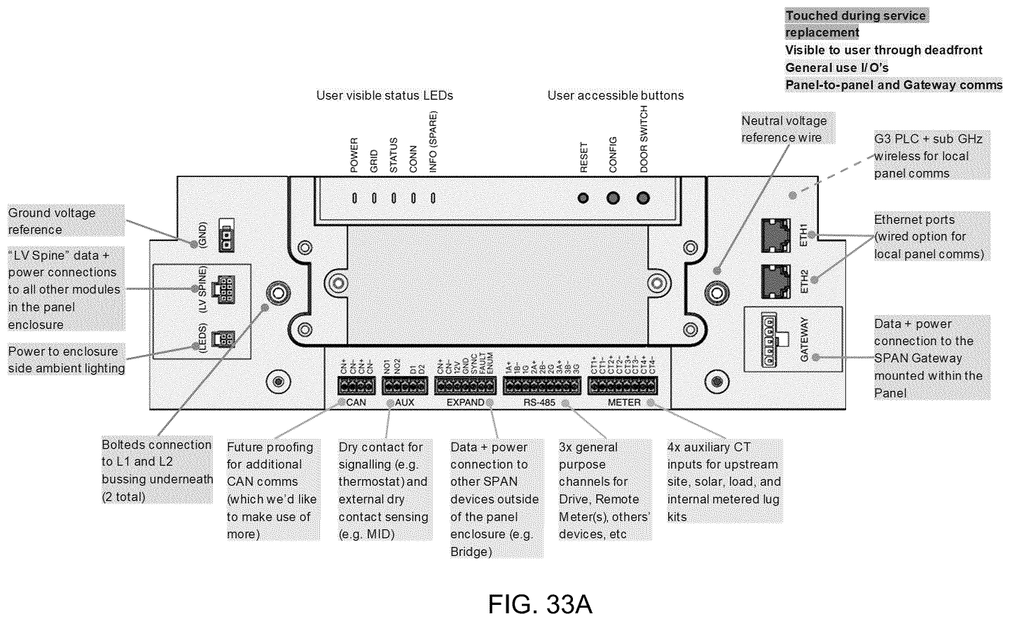

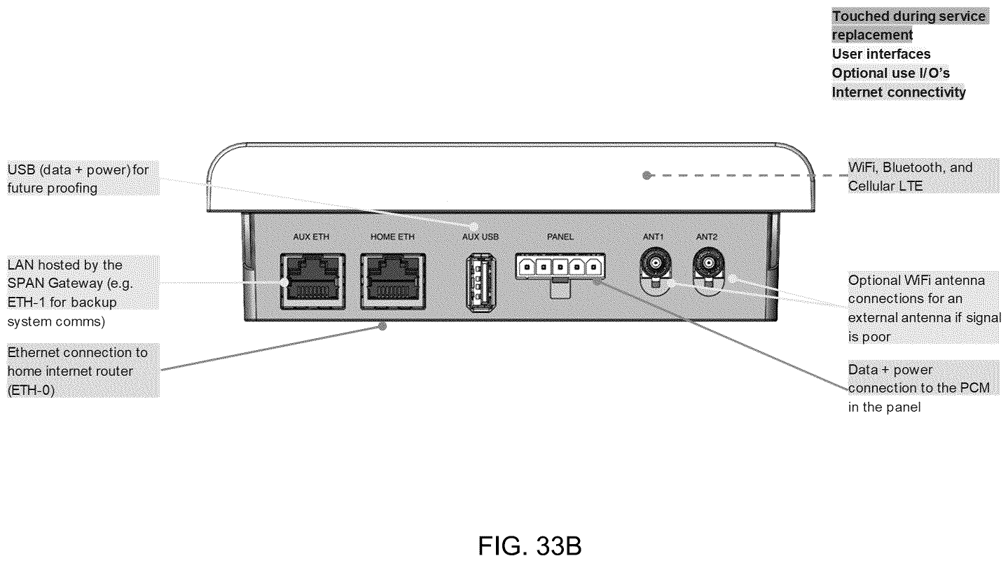

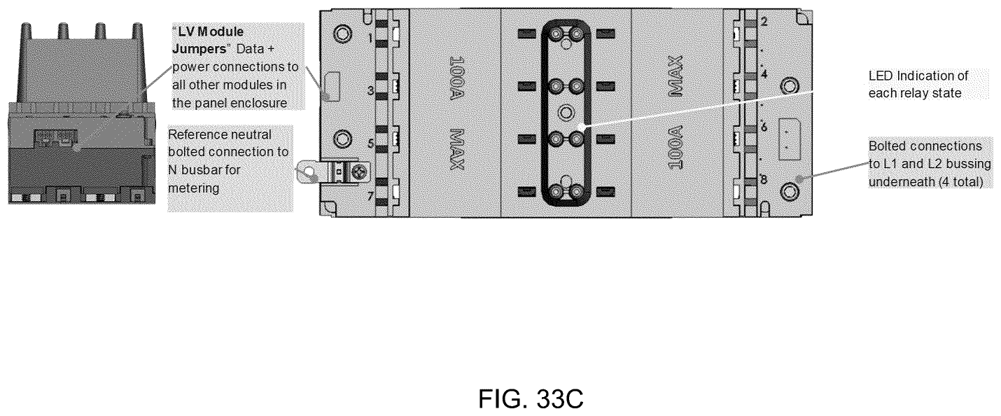

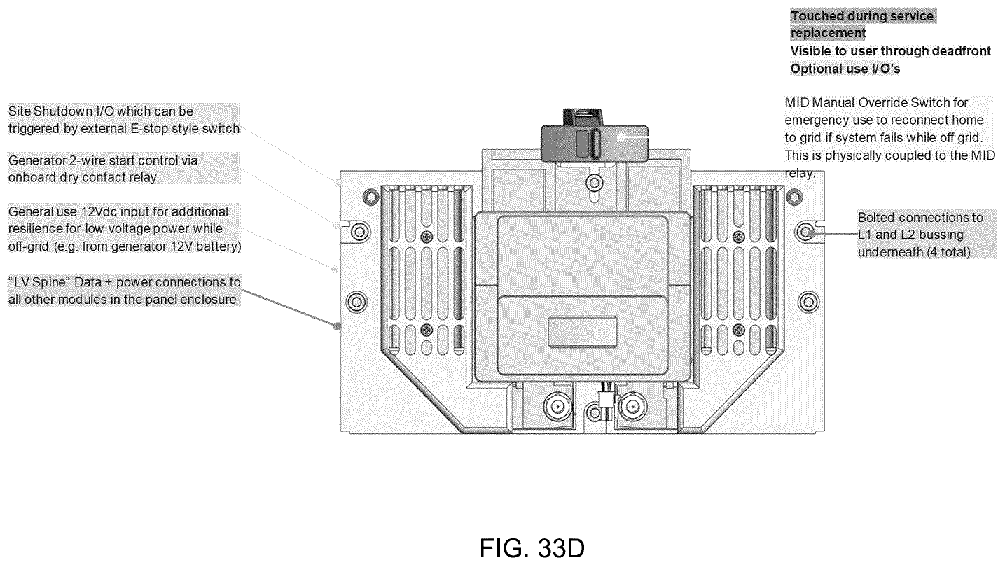

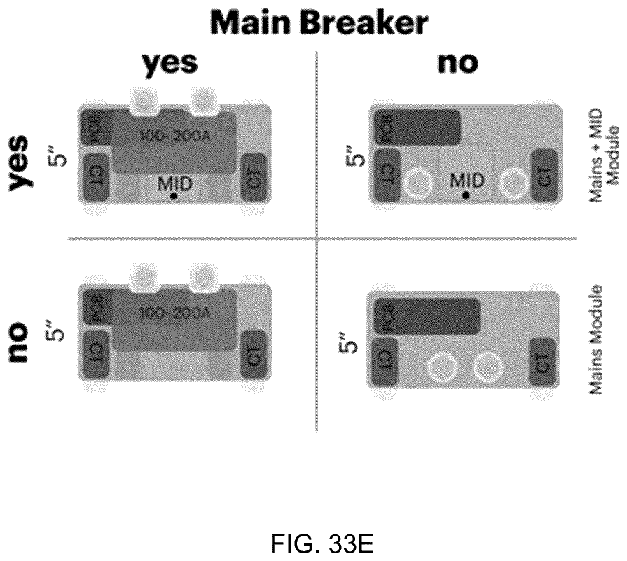

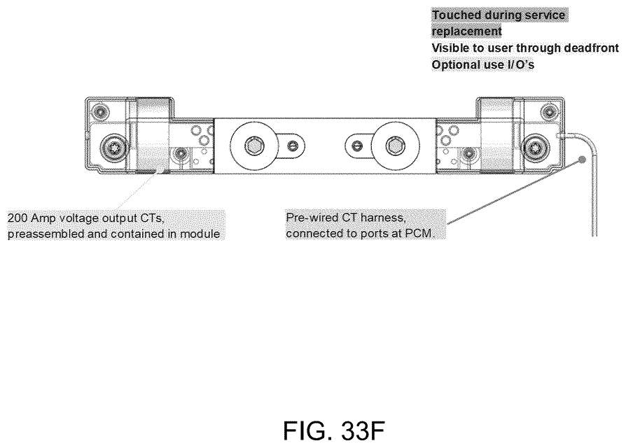

FIGS. 33A-33F show additional details of some of the chassis modules. FIG. 33A shows interfaces to the Panel Control Module. There may be one Panel Control Module per panel. FIG. 33B shows some interfaces to the gateway module. The gateway module may also include a user visible status LED, and a user accessible button for pairing. The gateway may also be removed and replaced by the user without shutting off power to the site. FIG. 33C shows interfaces to the branch control module. The chassis has slots for a certain number of branch control modules. In this example of the branch control module, there are 8× breaker spaces. The module accepts 1-inch breakers rated 10-100 A. It also accepts tandems and quads. FIG. 33D shows interfaces to the mains module. There may be different versions, for example one with a MID and one without a MID. This particular example accommodates main breaker (100, 125,150, 175, 200 Amp) options. It may also accept field-installable L1+L2 lugs in place of the main breaker, when not required on an MID-enabled module. FIG. 33E shows modules with different combinations of main breaker and MID capabilities. FIG. 33F shows a metered lug. This example can be installed at the top or bottom of the spine. It may also include terminals for whole home surge protection.

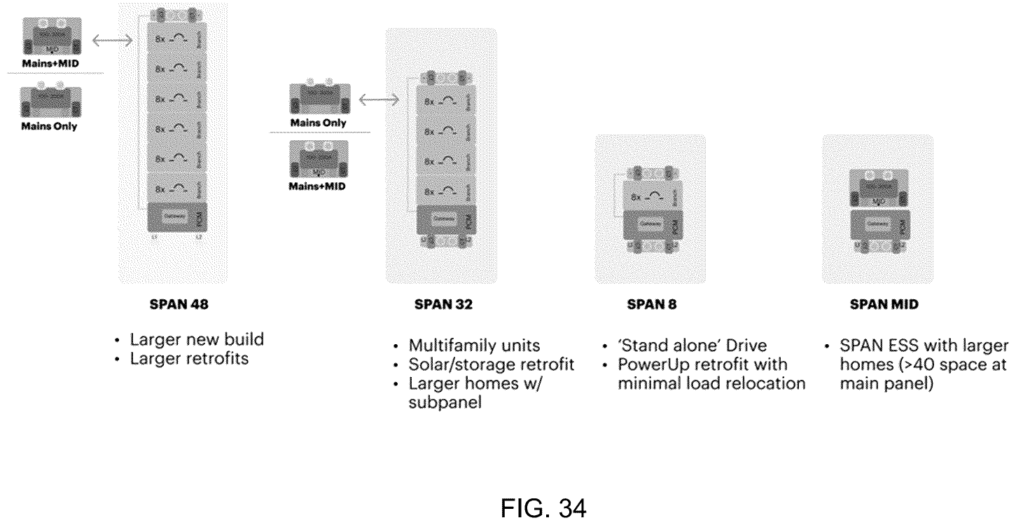

FIG. 34 shows different panels constructed using the modules of FIGS. 32-33.

### B. Example Customized Site Configurations

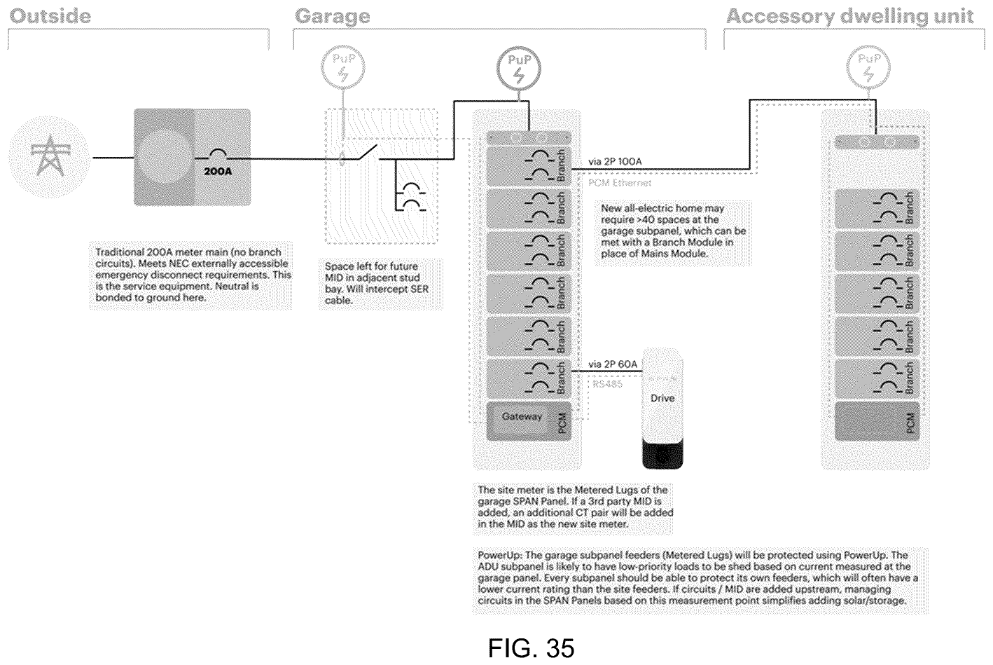

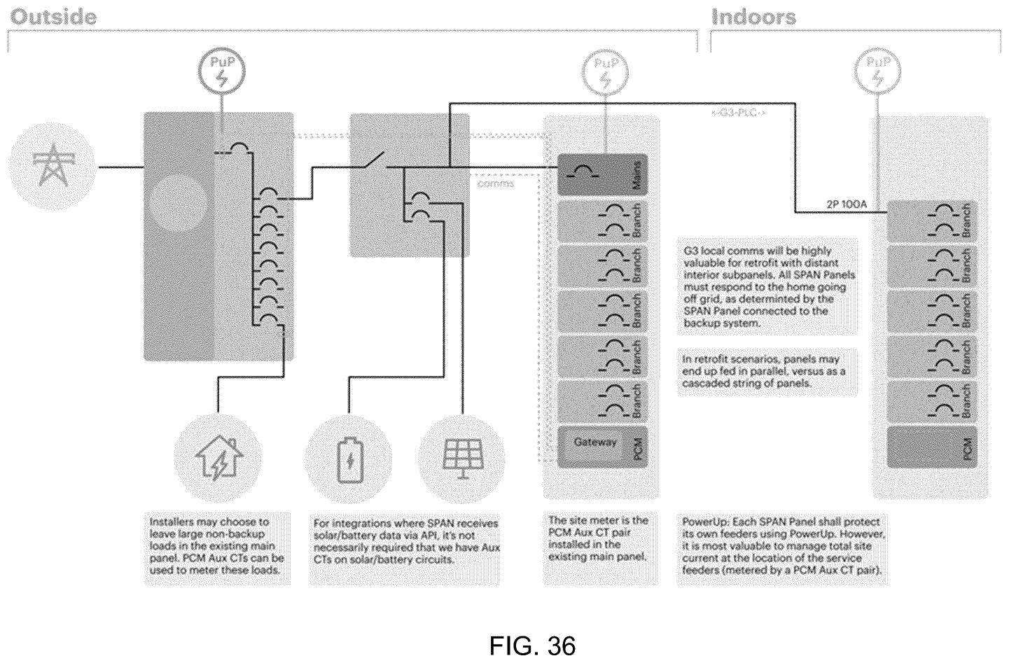

FIGS. 35 and 36 show two examples of sites configured using the modular system described herein. FIG. 35 is an example of a new all-electric home. FIG. 36 is an example of a whole-home backup retrofit.

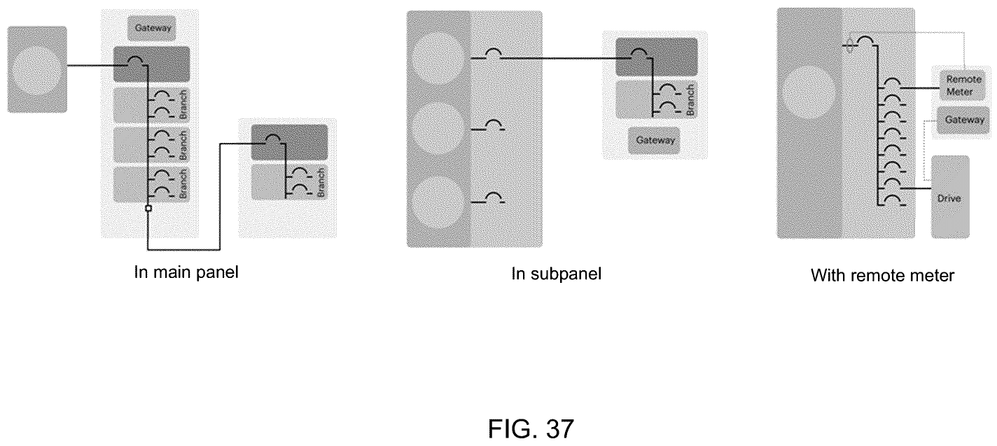

FIG. 37 shows different possible placements for the gateway module: in the main panel, in a subpanel, and with a remote meter.

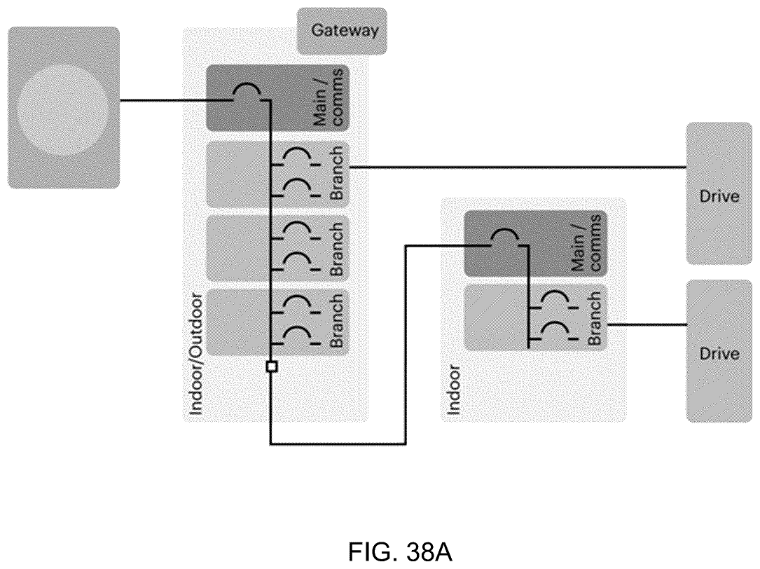

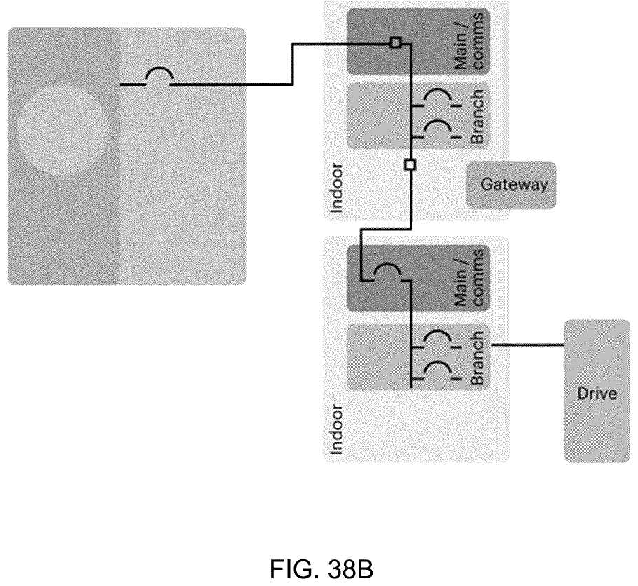

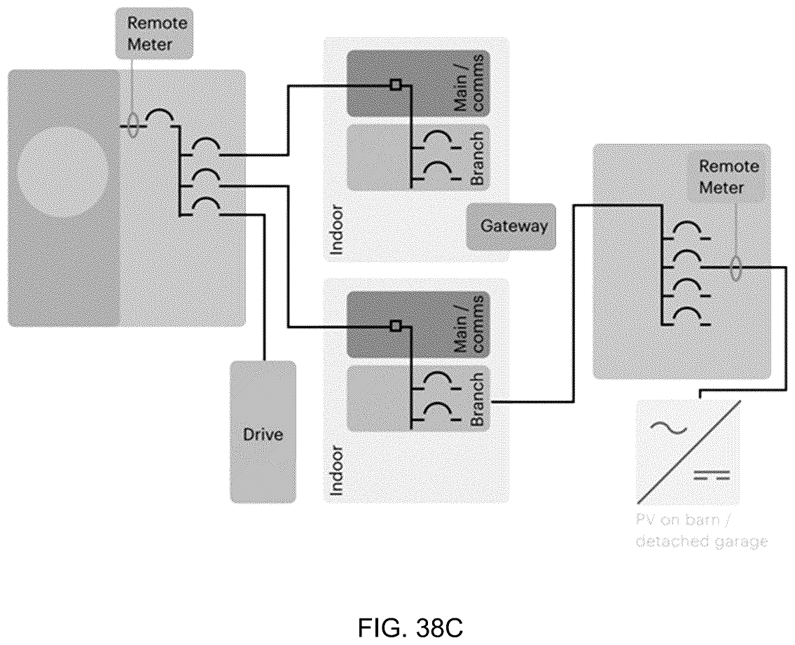

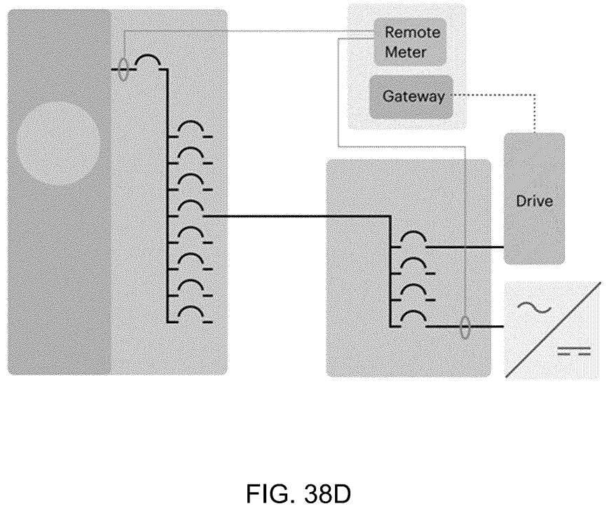

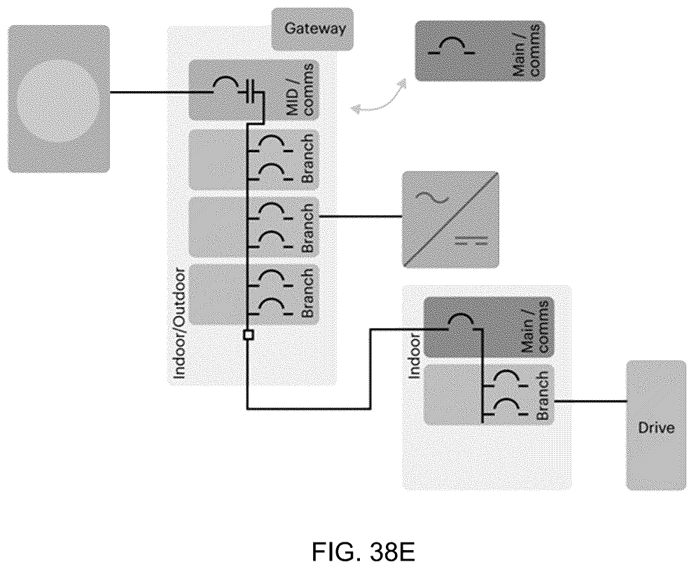

FIGS. 38A-38E show additional examples of site configurations. In FIG. 38A, there is one gateway per site. The main panel enclosure may be designed for indoor/outdoor. The subpanel can be designed for indoor only. Devices like Drive may be connected to main or sub panels. There may be an arbitrary number of subpanels/branch modules per site. The main/comms may or may not be a combined module. They are shown as a combined module in FIG. 38A.

In FIG. 38B, the subpanel ships with a main lug, with option for field-installed main breaker 100-200 A. The gateway can be installed in main or subpanel style enclosure. A 200 A feed-through is desired for series subpanels, but does not necessarily need to require 200 A+bussing in the subpanel (e.g. parallel service lugs).

FIG. 38C leverages a remote meter for auxiliary metering needs. Wired and wireless comms options may exist between different devices.

FIG. 38D uses a stand-alone gateway+remote meter configuration. This provides whole-home monitoring and control at a lower cost.

In FIG. 38E, the MID module is field-installed at later date. The hybrid inverter connection is restricted to the MID panel only, e.g. to solve for LV power sharing.

What is claimed is:

1. An electrical panel for managing a distribution of electrical power throughout a microgrid at a site, the electrical panel comprising:
a chassis comprising:
a bus structure that receives electrical power, and
a plurality of predefined attachment points for installation of field-replaceable control modules;
a field-replaceable branch module installed at one of the attachment points with electrical connection to the bus structure, the branch module distributing electrical power from the bus structure to a branch circuit of the microgrid and providing sensor, processor and/or actuator capabilities for the branch circuit;
a field-replaceable panel control module installed at one of the attachment points with electrical connection to the bus structure, wherein the panel control module maintains a registry that includes the installed branch module; and
an intra-panel communications network, over which the panel control module communicates data and control with the branch module.

2. The electrical panel of claim 1, further comprising at least one of: a field-replaceable head module installed in the electrical panel and registered with the panel control module, a field-replaceable MID control module installed in the electrical panel and registered with the panel control module; and a field-replaceable mains control module installed in the electrical panel and registered with the panel control module.

3. The electrical panel of claim 1, further comprising: a gateway connected to the panel control module and providing external communications to outside the site.

4. The electrical panel of claim 1, further comprising: a plurality of field-replaceable branch modules installed at the attachment points with electrical connection to the bus structure, wherein the branch modules and panel control module implement control loops for the branch circuits.

5. The electrical panel of claim 1, wherein the branch module provides at least one of: metering, relay control, power conversion, sensing, actuation, and conversion for the branch circuits.

6. The electrical panel of claim 1, further comprising: DC power distribution from the panel control module to the branch module, for providing DC electrical power to operate the branch module.

7. The electrical panel of claim 1, wherein the panel control module automatically registers and assigns a network address to the installed branch module, and the network address is determined based on a voltage divider connecting to the branch module.

8. The electrical panel of claim 1, wherein the branch module include terminals for the installation of a circuit breaker for the branch circuit.

9. The electrical panel of claim 1, wherein the branch module distributes electrical power to two or more branch circuits.

10. A microgrid control module for managing a distribution of electrical power throughout a microgrid at a site, the microgrid control module comprising:
a registry for maintaining a listing of field-installable control modules installed on the microgrid, the control modules providing sensor, processor and/or actuator capabilities for the microgrid;
a communications network, over which the microgrid control module communicates data and control with the control modules; and
a connection to a gateway, the gateway providing external communications to outside the site.

11. The microgrid control module of claim 10, wherein the microgrid control module aggregates data from the control modules, and the data is communicated off-site via the gateway.

12. The microgrid control module of claim 10, wherein the control modules provide sensor and actuator capabilities for control loops for the microgrid, and the microgrid control module provides processor capabilities for the control loops.

13. The microgrid control module of claim 10, wherein the microgrid control module records a state of the electrical power distribution throughout the microgrid.

14. The microgrid control module of claim 10, wherein the microgrid control module automatically registers and assigns a network address to the control modules in the registry.

15. A system for managing a distribution of electrical power throughout a microgrid at a site, the system comprising:
a plurality of field-installable control modules that provide sensor, processor and/or actuator capabilities for the microgrid;
a microgrid control module that maintain a registry of the installed control modules;
an intra-site communications network, over which the microgrid control module communicates data and control with the control modules; and
a gateway connected to the microgrid control module, the gateway connecting to an external communications network.

16. The system of claim 15, wherein at least one of the sensor and/or actuator capabilities is also field-replaceable.

17. The system of claim 15, wherein at least one of the field-installable control modules is also field-upgradeable.

18. The system of claim 15, wherein the system functionality is implementable by different site-level configurations that use different combinations of control modules.

19. The system of claim 15, wherein the system functionality is implementable by different site-level configurations that use different combinations of chassis control modules installed in electrical panels and standalone control modules external to electrical panels.

20. The system of claim 15, further comprising: off-site processing connected via the gateway and external communications network.
